(19) United States
(12) Patent Application Publication
(10) Pub. No.: US 2026/0174254 A1
(43) Pub. Date: Jun. 25, 2026

(54) TRANSFORMATIONAL DISPLAY DEVICES, SYSTEMS, AND METHODS

(71) Applicant: Andreas Hoenigschmid, Los Angeles, CA (US)

(72) Inventor: Andreas Hoenigschmid, Los Angeles, CA (US)

(21) Appl. No.: 19/127,186

(22) PCT Filed: Nov. 9, 2023
(86) PCT No.: PCT/US23/79234

§ 371 Date: May 5, 2025

Related U.S. Application Data
(60) Provisional application No. 63/383,078, filed on Nov. 10, 2022.

(51) Int. Cl. A47G 1/14; G06T 7/10

(52) U.S. Cl. CPC A47G 1/14; G06T 7/10; A47G 2001/145; G06T 2200/24; G06T 2207/20132

(57) ABSTRACT

A method of making a transformational display device, includes converting at least two different graphical images including a first graphical image and a second graphical image into partial image segments, forming a graphical surface treatment bearing the partial image segments of the at least two different graphical images, and applying the graphical surface treatment to a transformational display device. The transformational display device includes a plurality of polyhedrons connected by joints and configurable between a first display configuration and a second display configuration. In the first display configuration, adjacent and coplanar facets of the plurality of polyhedrons form a first planar display surface bearing contiguous partial image segments of the first graphical image, and in the second display configuration, adjacent and coplanar facets of the plurality of polyhedrons form a second planar display surface bearing contiguous partial image segments of the second graphical image.

### CROSS-REFERENCE TO RELATED APPLICATIONS

This application claims the benefit of U.S. Provisional Ser. No. 63/383,078, filed Nov. 10, 2022, the entirety of which is hereby incorporated by reference.

### TECHNICAL FIELD

The present disclosure relates to display devices and methods of forming and applying surface treatments, for example photographs, to display devices.

### BACKGROUND

Display devices for exhibiting static visual media images, such as photographs, paintings, illustrations, generally have a fixed shape and dimensions, which limits how the visual media is displayed and interacted with. For instance, photographs, paintings, and illustrations, are typically exhibited in a static frame device holding the photograph, painting, or illustration therein and then affixed to a wall or placed upon a table, stand, or other similar other support.

Recent developments have provided for more complicated framing systems in which multiple photographs, paintings, or illustrations can be placed in a number of adjoining frames having different shapes and/or sizes and irregular configurations. Recent developments have also provided for electronic frames in which a slide show of images can be shown on an electronic screen in a rotating sequential manner. However, these new developments in the field still suffer from the above drawbacks in that the display device itself, e.g., the frames, screen, etc., is static and non-interactive.

### BRIEF SUMMARY

Non-limiting examples of the present invention will now be described in the following numbered clauses:
Clause 1: A method of making a transformational display device, comprising: converting at least two different graphical images comprising a first graphical image and a second graphical image into partial image segments; forming a graphical surface treatment bearing the partial image segments of the at least two different graphical images; and applying the graphical surface treatment to a transformational display device comprising a plurality of polyhedrons connected by joints and configurable between a first display configuration and a second display configuration, such that in the first display configuration, adjacent and coplanar facets of the plurality of polyhedrons form a first planar display surface bearing contiguous partial image segments of the first graphical image, and in the second display configuration, adjacent and coplanar facets of the plurality of polyhedrons form a second planar display surface bearing contiguous partial image segments of the second graphical image.
Clause 2: The method according to clause 1, wherein the first display configuration and the second display configuration have different shapes.
Clause 3: The method according to clause 1 or clause 2, wherein the first planar display surface and the second planar display surface have different shapes.
Clause 4: The method of clause 3, wherein the first planar display surface has a rhomboid shape and the second planar display surface has a triangular shape.
Clause 5: The method of any one of clauses 1-4, wherein forming the graphical surface treatment comprises forming a first graphical surface treatment portion bearing at least one partial image segment of the first graphical image, and forming a second graphical surface treatment portion bearing at least one partial image segment of the second graphical image.
Clause 6: The method of clause 5, wherein forming the graphical surface treatment comprises forming the first graphical surface treatment portion bearing at least two partial image segments of the first graphical image, and forming the second graphical surface treatment portion bearing at least two partial image segments of the second graphical image.
Clause 7: The method of clause 5 or clause 6, wherein applying the graphical surface treatment comprises applying at least the first graphical surface treatment portion across the first planar display surface and applying at least the second graphical surface treatment portion across the second planar display surface.
Clause 8: The method of clause 7, wherein the first graphical surface treatment portion and the second graphical surface treatment portion form living hinges.
Clause 9: The method of any one of clauses 1-7, wherein each partial image segment of the first graphical image maps to a facet of the first planar display surface, and wherein each partial image segment of the second planar display surface maps a facet of the second planar display surface.
Clause 10: The method of any one of clauses 1-9, wherein applying the graphical surface treatment comprises applying the partial image segments of the first graphical image to facets of the first planar display surface, and applying the partial image segments of the second graphical image to facets of the second planar display surface.
Clause 11: The method of any one of clauses 1-10, wherein at least four adjacent and coplanar facets form the first planar display surface, wherein at least six adjacent and coplanar facets form the second planar display surface.
Clause 12: The method of any one of clauses 1-11, wherein the graphical surface treatment comprises triangular partial image segments of the at least two different graphical images.
Clause 13: The method of any one of clauses 1-12, wherein converting the at least two different graphical images into the partial image segments comprises receiving the at least two different graphical images in a digital format and dividing the at least two different graphical images into the partial image segments.
Clause 14: The method of clause 13, wherein forming the graphical surface treatment comprises printing the partial image segments on at least one substrate.
Clause 15: The method of clause 14, wherein forming the graphical surface treatment comprises forming a plurality of graphical surface treatment portions from the at least one substrate.
Clause 16: The method of any one of clauses 13-15, wherein converting the at least two graphical images into the partial image segments comprises cropping the at least two graphical images based upon a shape of the first planar display surface and a shape of the second planar display surface.
Clause 17: The method of clause 16, wherein the shape of the first planar display surface is a rhomboid shape and the shape of the second planar display surface is a triangular shape.
Clause 18: The method of any one of clauses 1-17, wherein in the first display configuration, facets of at least four of the plurality of polyhedrons form the first planar display surface.
Clause 19: The method according to clause 18, wherein in the second display configuration, facets of at least four of the plurality of polyhedrons form the second planar display surface.
Clause 20: The method of clause 19, wherein the first planar display surface and the second planar display surface have a same planar rhomboidal shape.
Clause 21: The method of clause 19, wherein the first planar display surface has a planar rhomboidal shape and the second planar display surface has a planar hexagonal shape.
Clause 22: The method of clause 19, wherein the first planar display surface has a rhomboidal shape and the second planar display surface has a planar triangular shape.
Clause 23: The method of any one of clauses 1-22, further comprising providing, through a graphical user interface, a preview of the at least two different graphical images on at least two planar display surfaces, including the first planar display surface and the second planar display surface.
Clause 24: A method of making a transformational display device, comprising: converting at least two different graphical images comprising a first graphical image and a second graphical image into partial image segments; forming a graphical surface treatment bearing the partial image segments of the at least two different graphical images; and applying the graphical surface treatment to a transformational display device comprising a plurality of polyhedrons connected by joints and configurable between a first display configuration and a second display configuration, wherein in the first display configuration, adjacent and coplanar facets of the plurality of polyhedrons form a first planar display surface, and in the second display configuration, adjacent and coplanar facets of the plurality of polyhedrons form a second planar display surface; wherein each partial image segment of the first graphical image maps to a facet of the first planar display surface, and wherein each partial image segment of the second planar display surface maps to a facet of the second planar display surface; wherein applying the graphical surface treatment comprises applying the partial image segments of the first graphical image to facets of the first planar display surface, and applying the partial image segments of the second graphical image to facets of the second planar display surface.
Clause 25: A method of making a transformational display device comprising a plurality of polyhedrons connected by joints and configurable between a first display configuration and a second display configuration, wherein in the first display configuration, adjacent and coplanar facets of the plurality of polyhedrons form a first planar display surface, and in the second display configuration, adjacent and coplanar facets of the plurality of polyhedrons form a second planar display surface, the method comprising: converting at least two different graphical images comprising a first graphical image and a second graphical image into partial image segments; forming a graphical surface treatment bearing the partial image segments of the at least two different graphical images, wherein each partial image segment of the first graphical image maps to a facet of the first planar display surface, and wherein each partial image segment of the second planar display surface maps to a facet of the second planar display surface; and applying the graphical surface treatment to the transformational display device by applying the partial image segments of the first graphical image to facets of the first planar display surface, and applying the partial image segments of the second graphical image to facets of the second planar display surface.
Clause 26: A transformational display device, comprising: a plurality of polyhedrons connected by joints and configurable between at least a first display configuration and a second different display configuration, wherein each polyhedron of the plurality of polyhedrons comprises a plurality of facets; and at least one graphical surface treatment exhibiting at least a first set of image segments converted from a first graphical image and a second set of image segments converted from a second graphical image, wherein in each of the first and second display configurations, at least two of the plurality of polyhedrons form a planar display surface comprising adjacent and coplanar display facets of the at least two polyhedrons, wherein the first set of image segments and the second set of image segments exhibited on the at least one graphical surface treatment are mapped to the facets of the plurality of polyhedrons such that the planar display surface formed in the first display configuration contiguously exhibits the first graphical image and the planar display surface formed in the second display configuration contiguously exhibits the second graphical image.
Clause 27: The transformational display device of clause 26, wherein the at least one graphical surface treatment comprises a decal, an adhesive-backed label, a printed layer of ink, a printed layer of paint, a printed layer of dye, an etching, an engraving, an embossment, or an inscription.
Clause 28: The transformational display device of clause 26 or clause 27, wherein each image segment comprises a different, non-repeating portion of one of the first and second graphical images.
Clause 29: The transformational display device of any one of clauses 26-28, wherein the at least one graphical surface treatment is disposed on a common substrate.
Clause 30: The transformational display device of any one of clauses 26-29, wherein the first and second graphical images comprise photographs.
Clause 31: The transformational display device of any one of clauses 26-30, wherein the at least one graphical surface treatment comprises a plurality of substrates having the sets of image segments imprinted thereon, and wherein the plurality of substrates are applied to the facets.
Clause 32: The transformational display device of clause 31, wherein the plurality of substrates comprises a plurality of decals configured to be adhered to the facets.
Clause 33: The transformational display device of clause 31, wherein the plurality of substrates comprises a plurality of adhesive-backed labels configured to be adhered to the facets.
Clause 34: The transformational display device of any one of clauses 31-33, wherein at least one of the plurality of substrates has at least two image segments imprinted thereon, the at least one substrate being applied to two adjoining facets.
Clause 35: The transformational display device of clause 34, wherein the two adjoining facets are facets of one of the plurality of polyhedrons.
Clause 36: The transformational display device of clause 34, wherein the two adjoining display facets are facets of two adjoining polyhedrons.
Clause 37: The transformational display device of clause 36, wherein the joint between the two adjoining polyhedrons comprises the at least one substrate, i.e., the at least one substrate forms a living hinge, and wherein the at least two image segments imprinted on the at least one substrate are divided along the joint.
Clause 38: The transformational display device of any one of clauses 34-37, wherein the at least two image segments are taken from a common set of image segments and comprise portions of the same graphical image.
Clause 39: The transformational display device of any one of clauses 34-38, wherein the at least two image segments are taken from different sets of image segments and comprise portions of different graphical images.
Clause 40: The transformational display device of any one of clauses 34-39, wherein the two adjoining display facets form at least a portion of one of the planar display surfaces.
Clause 41: The transformational display device of any one of clauses 34-40, wherein the two adjoining facets form portions of different planar display surfaces.
Clause 42: The transformational display device of any one of clauses 31-41, wherein the plurality of substrates comprises twenty-four substrates having at least twelve sets of image segments imprinted thereon.
Clause 43: The transformational display device of any one of clauses 31-42, wherein at least a portion of at least one of the sets of image segments is imprinted on separate substrates applied to non-adjoining facets.
Clause 44: The transformational display device of clause 43, wherein at least a portion of at least one of the sets of image segments is imprinted on a common substrate applied to adjoining facets.
Clause 45: The transformational display device of any one of clauses 26-44, wherein in at least one of the display configurations, four of the plurality of polyhedrons form a non-square rhomboidal planar display surface comprising adjacent and coplanar facets of the four polyhedrons.
Clause 46: The transformational display device of any one of clauses 26-45, wherein in at least one of the display configurations, at least two of the plurality of polyhedrons form a square planar display surface comprising adjacent and coplanar facets of the at least two polyhedrons.
Clause 47: The transformational display device of any one of clauses 26-47, wherein in at least one of the display configurations, at least two of the plurality of polyhedrons form a non-square rectangular planar display surface comprising adjacent and coplanar facets of the at least two polyhedrons.
Clause 48: The transformational display device of any one of clauses 26-48, wherein in at least one of the display configurations, six of the plurality of polyhedrons form a hexagonal display surface comprising adjacent and coplanar facets of the six polyhedrons.
Clause 49: The transformational display device of any one of clauses 26-48, wherein in at least one of the display configurations, eight of the plurality of polyhedrons form a triangular planar display surface comprising adjacent and coplanar facets of the eight polyhedrons.
Clause 50: The transformational display device of any one of clauses 26-49, wherein the plurality of polyhedrons comprises twelve polyhedrons arranged in a continuous loop and/or a chain.
Clause 51: The transformational display device of clause 50, wherein the plurality of polyhedrons comprise a plurality of different geometric shapes arranged in an alternating sequence.
Clause 52: The transformational display device of clause 51, wherein the plurality of polyhedrons comprise two different geometric shapes arranged in an alternating sequence.
Clause 53: The transformational display device of any one of clauses 50-52, wherein each of the polyhedrons have edge lengths which are either one unit, the square root of two units (√(2) units), 2 units, or the square root of three units (√(3) units).
Clause 54: The transformational display device of any one of clauses 50-52, wherein each of the polyhedrons have edge lengths which are either one-half the square root of two units (0.5√(2) units), one unit, the square root of one and one-half units (√(1.5) units), or the square root of two units (√(2) units).
Clause 55: The transformational display device of any one of clauses 26-54, wherein each of the polyhedrons is a tetrahedron.
Clause 56: The transformational display device of any one of clauses 26-55, wherein the display configurations of the plurality of polyhedrons comprise arrangements of the plurality of polyhedrons in different geometric shapes and the planar display surface formed in each of the display configurations comprises an external outermost surface of the geometric shapes.
Clause 57: The transformational display device of clause 56, wherein at least one of the display configurations comprises an arrangement of the plurality of polyhedrons in a cuboid.
Clause 58: The transformational display device of clause 56 or 57, wherein at least one of the display configurations comprises an arrangement of the plurality of polyhedrons in a rectangular parallelepiped.
Clause 59: The transformational display device of any one of clauses 56-58, wherein at least one of the display configurations comprises an arrangement of the plurality of polyhedrons in two adjoining pyramids.
Clause 60: The transformational display device of clause 59, wherein the two adjoining pyramids are arranged with respective faces thereof in an abutting engagement.
Clause 61: The transformational display device of clause 59, wherein the two adjoining pyramids are hingedly connected along respective edges thereof.
Clause 62: The transformational display device of any one of clauses 56-61, wherein the display configurations comprise arrangements of the plurality of polyhedrons in the same geometric shape.
Clause 63: The transformational display device of any one of clauses 56-61, wherein the display configurations comprise arrangements of the plurality of polyhedrons in different geometric shapes.
Clause 64: The transformational display device of any one of clauses 26-63, wherein at least two planar display surfaces are formed in at least one of the display configurations.
Clause 65: The transformational display device of clause 64, wherein the at least two planar display surfaces are non-parallel.
Clause 66: The transformational display device of clause 64, wherein the at least two planar display surfaces are co-planar.
Clause 67: The transformational display device of any one of clauses 26-66, wherein each of the plurality of polyhedrons comprises at least one magnet disposed proximal to at least one facet thereof, the magnets being configured to stabilize the plurality of polyhedrons in the display configurations.
Clause 68: The transformational display device of clause 67, wherein each of the plurality of polyhedrons comprises at least one magnet disposed proximal to every facet thereof.
Clause 69: The transformational display device of clause 67 or clause 68, wherein the at least one magnet of each polyhedron has an opposite polarity of the at least one magnet of each adjacent polyhedron.
Clause 70: The transformational display device according to any one of clauses 26-69, wherein the plurality of polyhedrons comprises a foldable substrate comprising the plurality of facets connected to each other and configured to form the plurality of polyhedrons.
Clause 71: A method of making a transformational display device, comprising: converting at least two different graphical images comprising a first graphical image and a second graphical image into partial image segments; forming a graphical surface treatment bearing the partial image segments of the at least two different graphical images; and applying the graphical surface treatment to a transformational display device according to any one of clauses 26-70 such that in the first display configuration, adjacent and coplanar facets of the plurality of polyhedrons form a first planar display surface bearing contiguous partial image segments of the first graphical image, and in the second display configuration, adjacent and coplanar facets of the plurality of polyhedrons form a second planar display surface bearing contiguous partial image segments of the second graphical image.
Clause 72: A method of making a transformational display device of any one of clauses 26-70, the method comprising: converting at least two different graphical images comprising a first graphical image and a second graphical image into partial image segments; forming a graphical surface treatment bearing the partial image segments of the at least two different graphical images, wherein each partial image segment of the first graphical image maps to a facet of the first planar display surface, and wherein each partial image segment of the second planar display surface maps to a facet of the second planar display surface; and applying the graphical surface treatment to the transformational display device by applying the partial image segments of the first graphical image to facets of the first planar display surface, and applying the partial image segments of the second graphical image to facets of the second planar display surface.
Clause 73: A method of making a transformational display device, comprising: converting at least two different graphical images comprising a first graphical image and a second graphical image into partial image segments; forming a graphical surface treatment bearing the partial image segments of the at least two different graphical images; and applying the graphical surface treatment to a transformational display device according to any one of clauses 26-70; wherein each partial image segment of the first graphical image maps to a facet of the first planar display surface, and wherein each partial image segment of the second planar display surface maps to a facet of the second planar display surface; wherein applying the graphical surface treatment comprises applying the partial image segments of the first graphical image to facets of the first planar display surface, and applying the partial image segments of the second graphical image to facets of the second planar display surface.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1A schematically illustrates surface features of a transformational display device according to an example of the present disclosure.

FIG. 1B illustrates a schematic of the geometric configuration of polyhedrons of the transformational display device of FIG. 1A.

FIG. 1C illustrates a legend for interpreting the line patterns shown in FIG. 1B.

FIG. 2 schematically illustrates surface features of a transformational display device incorporating magnetic features according to an example of the present disclosure.

FIG. 3A illustrates a schematic of a planar display surface according to an example of the present disclosure.

FIG. 3B illustrates a schematic of a planar display surface according to an example of the present disclosure.

FIG. 3C illustrates a schematic of a planar display surface according to an example of the present disclosure.

FIG. 3D illustrates a schematic of a planar display surface according to an example of the present disclosure.

FIG. 3E illustrates a schematic of a planar display surface according to an example of the present disclosure.

FIG. 3F illustrates a schematic of a planar display surface according to an example of the present disclosure.

FIG. 3G illustrates a schematic of a planar display surface according to an example of the present disclosure.

FIG. 3H illustrates a schematic of a planar display surface according to an example of the present disclosure.

FIG. 3I illustrates a schematic of a planar display surface according to an example of the present disclosure.

FIG. 3J illustrates a schematic of a planar display surface according to an example of the present disclosure.

FIG. 4 illustrates a transformational display device configurable between different display configurations according to an example of the present disclosure.

FIG. 5A illustrates a schematic of a graphical surface treatment applicable to the transformational display device of FIG. 4.

FIG. 5B illustrates a schematic of a planar display surface formed with the graphical surface treatment of FIG. 5A.

FIG. 5C illustrates a schematic of a planar display surface formed with the graphical surface treatment of FIG. 5A.

FIG. 5D illustrates a schematic of planar display surfaces formed with the graphical surface treatment of FIG. 5A.

FIG. 5E illustrates a schematic of planar display surfaces formed with the graphical surface treatment of FIG. 5A.

FIG. 5F illustrates a schematic of planar display surfaces formed with the graphical surface treatment of FIG. 5A.

FIG. 6 illustrates a transformational display device configurable between different display configurations according to another example of the present disclosure.

FIG. 7A illustrates a schematic of a graphical surface treatment applicable to the transformational display device of FIG. 6.

FIG. 7B illustrates a schematic of planar display surfaces formed with the graphical surface treatment of FIG. 7A.

FIG. 7C illustrates a schematic of planar display surfaces formed with the graphical surface treatment of FIG. 7A.

FIG. 7D illustrates a schematic of planar display surfaces formed with the graphical surface treatment of FIG. 7A.

FIG. 7E illustrates a schematic of planar display surfaces formed with the graphical surface treatment of FIG. 7A.

FIG. 8 illustrates a transformational display device configurable between different display configurations according to still another example of the present disclosure.

FIG. 9A illustrates a schematic of a graphical surface treatment applicable to the transformational display device of FIG. 8.

FIG. 9B illustrates a schematic of planar display surfaces formed with the graphical surface treatment of FIG. 9A.

FIG. 9C illustrates a schematic of planar display surfaces formed with the graphical surface treatment of FIG. 9A.

FIG. 9D illustrates a schematic of planar display surfaces formed with the graphical surface treatment of FIG. 9A.

FIG. 10A illustrates a flow chart for a method according to an example of the present disclosure.

FIG. 10B illustrates a flow chart for further steps of the method of FIG. 10A.

FIG. 10C illustrates a flow chart for further steps of the method of FIG. 10A.

FIG. 11 illustrates a substrate for use in the method of FIG. 10A-FIG. 10C according to an example of the present disclosure.

FIG. 12A illustrates a schematic of a geometric configuration of polyhedrons of one or more transformational display devices according to an example of the present disclosure.

FIG. 12B illustrates a legend for interpreting the line patterns shown in FIG. 12A.

FIG. 12C schematically illustrates surface features of a transformational display device incorporating the polyhedrons of FIG. 12A according to an example of the present disclosure.

FIG. 12D schematically illustrates surface features of a transformational display device incorporating the polyhedrons of FIG. 12A according to an example of the present disclosure.

FIG. 12E schematically illustrates surface features of a transformational display device incorporating the polyhedrons of FIG. 12A according to an example of the present disclosure.

FIG. 12F schematically illustrates surface features of a transformational display device incorporating the polyhedrons of FIG. 12A according to an example of the present disclosure.

### DETAILED DESCRIPTION

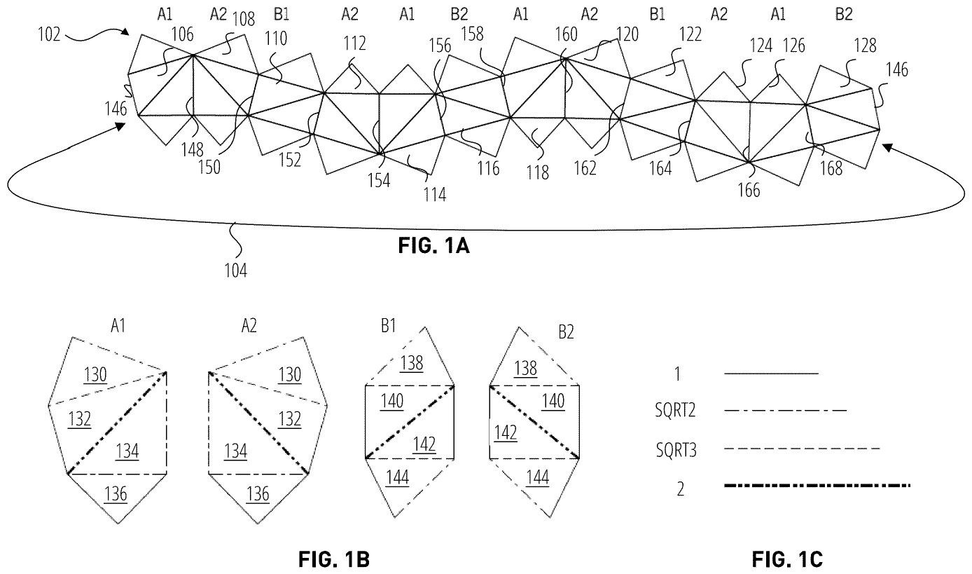

With reference to FIG. 1A-FIG. 12F, the following disclosure is generally directed to customizable transformational display devices and methods for making such devices. The transformational display devices discussed below address the above-noted drawbacks in prior display devices by providing display devices that can be physically manipulated into different display configurations having different shapes and providing different display surfaces for exhibiting different pieces of visual media applied to the display device.

A general introduction is provided first, followed by a detailed description of representative embodiments.

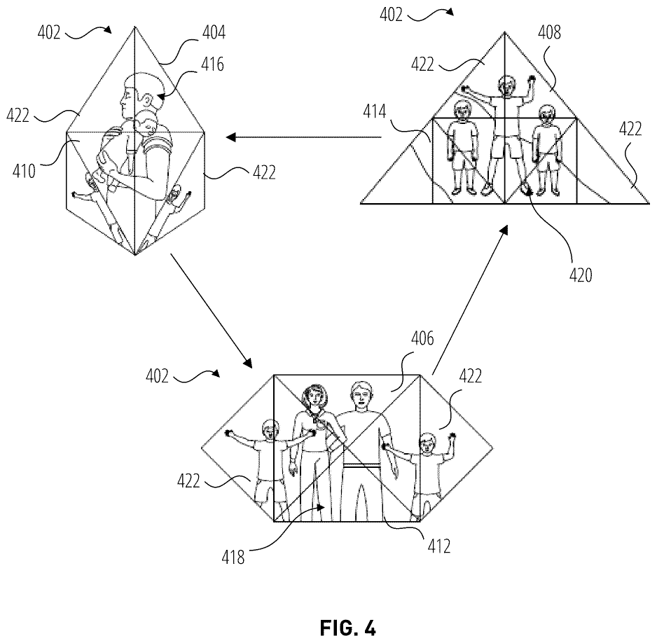

With reference to FIG. 4-FIG. 9D, a transformational display device 402, 602, 802 of the type discussed below with reference to FIG. 4-FIG. 9D and to the schematic illustrations of FIG. 1A-FIG. 1C can be physically manipulated to achieve various display configurations in which a plurality of polyhedrons connected by joints form geometric shapes having one or more external planar display surfaces comprised of adjacent and coplanar facets of at least two of the polyhedrons. Such planar display surfaces are particularly suitable for projecting graphical images, such as drawings, pictures, or photographs, distributed across the facets forming each of the planar display surfaces.

In this manner, one or more physical graphical surface treatments comprised of sets of segments of different graphical images (partial image segments) can be applied to some or all of the facets 130, 132, 134, 136, 138, 140, 142, 144 of the plurality of polyhedrons 106, 108, 110, 112, 114, 116, 118, 120, 122, 124, 126, 128. As the transformational display device 102 is manipulated into the various different display configurations (e.g., having different overall geometries), the facets 130, 132, 134, 136, 138, 140, 142, 144 of the different polyhedrons 106, 108, 110, 112, 114, 116, 118, 120, 122, 124, 126, 128 having the one or more graphical surface treatments applied thereto, i.e., display facets, are brought into different positional arrangements with respect to each other. When a display configuration is achieved, at least two display facets become positioned adjacent to and coplanar with each other to form a planar display surface, which contiguously exhibits at least one of the graphical images segmented within the at least one graphical surface treatment.

As the transformational display device 102 is further manipulated, the display facets become rearranged with respect to each other and the image segments formed from one graphical image may be pulled apart or concealed within the geometric shape of the transformational display device 102 and a different geometric shape forming a different planar display surface, which exhibits a different graphical image, can be achieved.

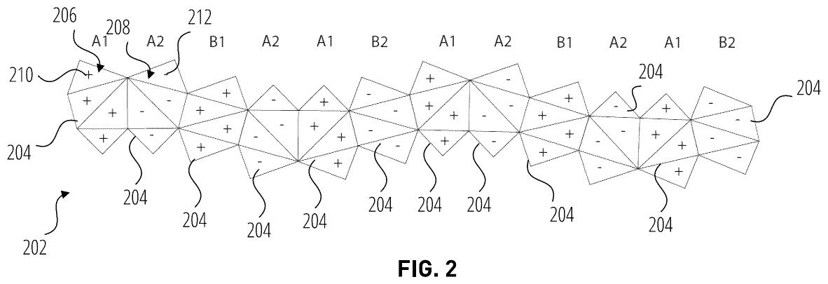

Accordingly, the present disclosure provides for an interactive and transformable transformational display device that can be physically manipulated to exhibit different contiguous graphical images in a dynamic and engaging manner that provides visual and tactile feedback when the different display configurations are achieved and the different graphical images are contiguously exhibited. Additionally, the transformational display device can be arranged into different three-dimensional geometric shapes and stabilized by optional magnets 210, 212, as discussed below with reference to FIG. 2. Therefore, the transformational display device can be maintained in any one of the different display configurations and is suitable for exhibiting any one of the graphical images in a static manner when not being manipulated.

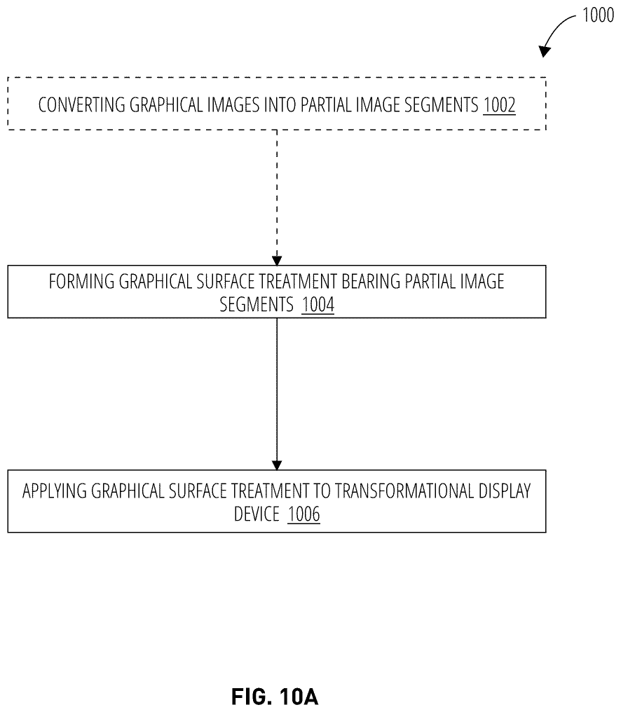

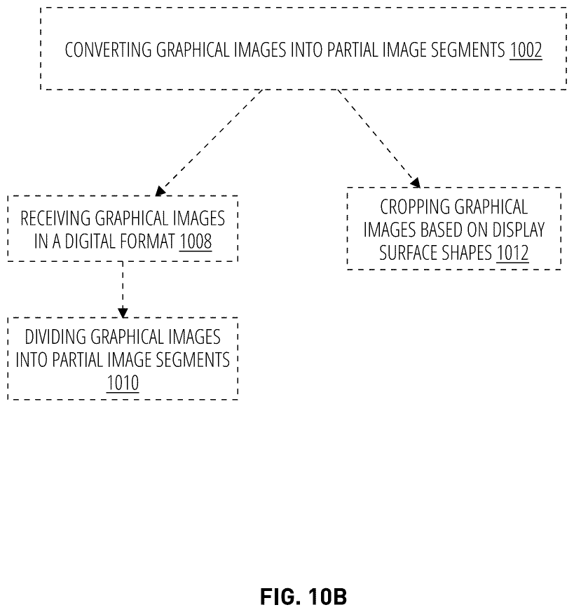

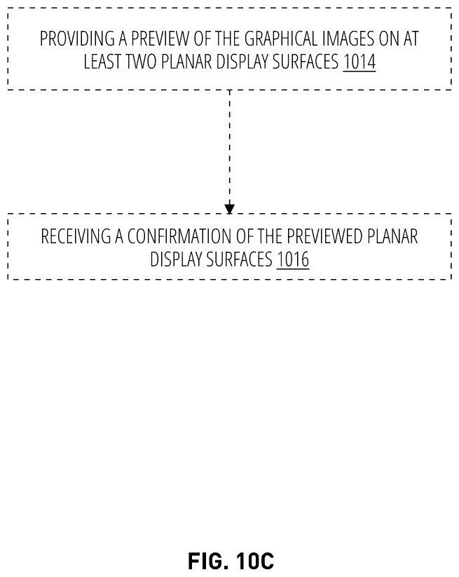

The present disclosure also provides exemplary methods or processes, described below with reference to FIG. 10A-FIG. 10C, that take advantage of the interactive and transformable nature of the transformational display device to provide a transformational display device having display facets imprinted with pluralities of partial image segments, e.g., taken from graphical images received from or selected by a third party (e.g., consumer). The transformational display device can be manipulated and rearranged as described above to contiguously exhibit the received graphical images.

According to one example, the graphical images exhibited by the transformational display device are photographs selected or provided by a consumer, such as personal or family photographs. According to another example, the graphical images exhibited by the transformational display device are photographs, drawings, images, or other graphic directed to a common theme, e.g., a promotional item or a collectible. According to yet another example, the graphical images exhibited by the transformational display device may be arranged sequentially such that the transformational display device shows a sequential story or event as the transformational display device is manipulated through the different display configurations. Advantageously, the methods enable mass customization of the transformational display devices. For example, the methods can be performed utilizing different graphical images for different consumers.

A detailed description of representative embodiments will now be provided.

FIG. 1A-FIG. 1C schematically illustrate surface features of a representative transformational display device 102 suitable for customization according to methods of the present disclosure. The transformational display device 102 includes a plurality of polyhedrons 106, 108, 110, 112, 114, 116, 118, 120, 122, 124, 126, 128 connected by joints (e.g., living hinges) 146, 148, 150, 152, 154, 156, 158, 160, 162, 164, 166, 168 and configurable between different display configurations, as will be described below. As shown in FIG. 1B, each polyhedron of the plurality of polyhedrons 106, 108, 110, 112, 114, 116, 118, 120, 122, 124, 126, 128 comprises a plurality of facets 130, 132, 134, 136, 138, 140, 142, 144.

As shown in FIG. 1A, the plurality of polyhedrons 106, 108, 110, 112, 114, 116, 118, 120, 122, 124, 126, 128 includes twelve polyhedrons coupled together by joints in a chain (here, a continuous loop arrangement 104). Each of the polyhedrons 106, 108, 110, 112, 114, 116, 118, 120, 122, 124, 126, 128 may be a solid body, optionally having a cavity formed therein, and may be formed from a thermoplastic polymer (e.g., PLA) or other rigid material. To clarify, the polyhedrons described herein are not limited to bodies which are completely solid. In some embodiments, one or more of the polyhedrons may be hollow (i.e., having a cavity therein) and may have one or more cut-outs from its volume. Although representative embodiments comprising twelve polyhedrons are described herein, the transformational display devices and methods are not limited to twelve polyhedrons. Indeed, transformational display devices of this disclosure may include twenty four or other number of polyhedrons

The polyhedrons 106, 108, 110, 112, 114, 116, 118, 120, 122, 124, 126, 128 are hingedly coupled together at the joints 146, 148, 150, 152, 154, 156, 158, 160, 162, 164, 166, 168 in an end-to-end chain configuration, e.g., either an open-ended chain or a continuous loop. It is to be appreciated that the joints 146, 148, 150, 152, 154, 156, 158, 160, 162, 164, 166, 168 may be formed in any suitable structure for achieving the display configurations to be described below. According to an example, the joints 146, 148, 150, 152, 154, 156, 158, 160, 162, 164, 166, 168 may be formed as hinges (e.g., living hinges) from the one or more graphical surface treatments to be applied to the transformational display device 102, as will be described below.

According to another example, the joints 146, 148, 150, 152, 154, 156, 158, 160, 162, 164, 166, 168 are formed integrally with the polyhedrons 106, 108, 110, 112, 114, 116, 118, 120, 122, 124, 126, 128 (e.g., living hinges) and extend directly from one of the polyhedrons to an adjoining polyhedron. In such an example, the joints 146, 148, 150, 152, 154, 156, 158, 160, 162, 164, 166, 168 may be formed as a flexible polymer strip of a same or similar material as the outer shell of the polyhedrons. In another example, the joints 146, 148, 150, 152, 154, 156, 158, 160, 162, 164, 166, 168 are formed as one or more internal flexible connection strips (e.g., of a thin flexible polymer, metal, or textile) extending between adjoining polyhedrons and configured to be anchored within internal cavities of the adjoining polyhedrons.

In any embodiment, the joint(s) may each exclude a hub.

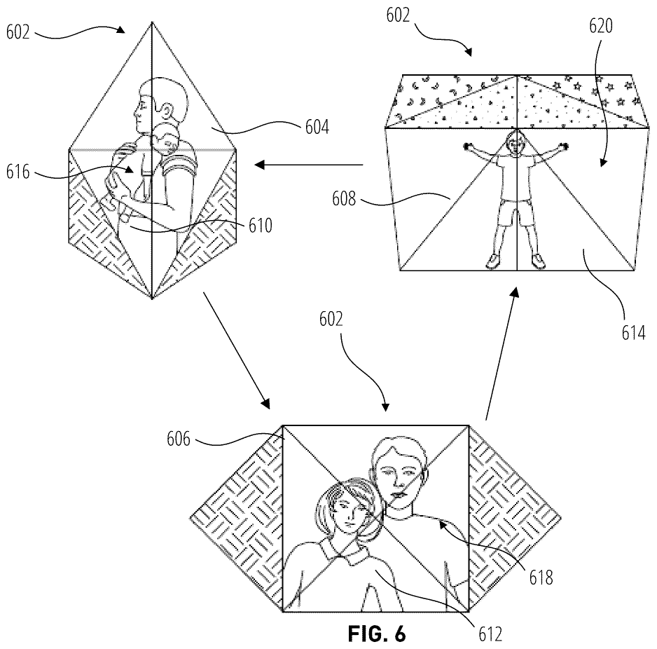

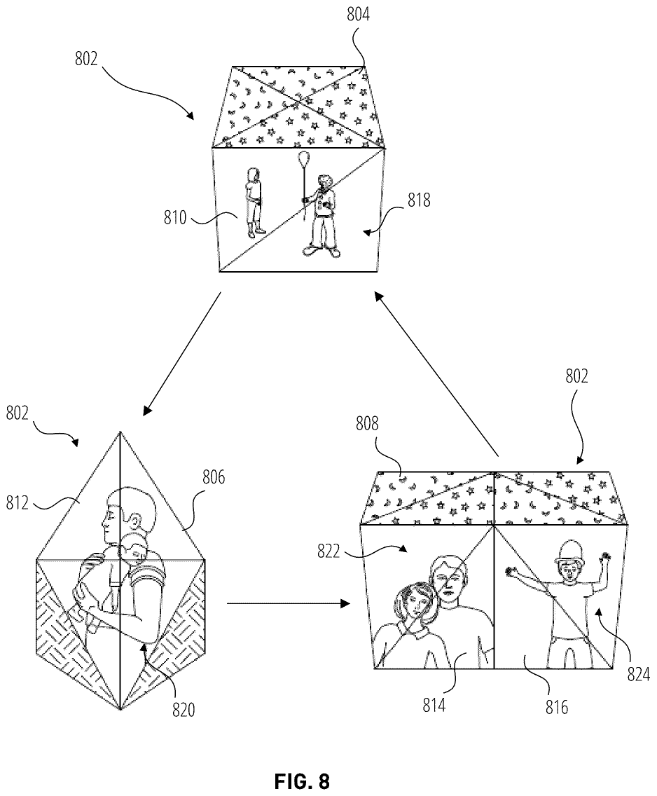

By manipulating the polyhedrons 106, 108, 110, 112, 114, 116, 118, 120, 122, 124, 126, 128, the transformational display device 102 may be arranged into numerous different display configurations in which the plurality of polyhedrons form geometric shapes with at least one flat or substantially flat external or outermost surface made up of adjacent and coplanar facets 130, 132, 134, 136, 138, 140, 142, 144. FIG. 4, FIG. 6, and FIG. 8 illustrate representative display configurations, including one or more rectangular parallelepiped display configurations 608, 808 made up of two hingedly connected parallelepipeds, one or more display configurations 404, 406, 408, 604, 606, 806 made up of two adjoining pyramids 422 hingedly connected along their respective edges, and one or more cuboid display configurations 804. One or more display configurations 404, 604, 806 may be made up of the two adjoining pyramids 422 arranged with their respective faces in an abutting engagement. It is to be appreciated that the various display configurations described above are exemplary and many other display configurations may be achieved depending on the specific geometries of the transformational display device 102.

Returning to FIG. 1A-FIG. 1C, the transformational display device 102 is formed in the continuous loop arrangement 104 of the twelve hingedly connected polyhedrons 106, 108, 110, 112, 114, 116, 118, 120, 122, 124, 126, 128, wherein each polyhedron is a tetrahedron, i.e., a polyhedron having four polyhedral, e.g., triangular, facets. Each polyhedron 106, 108, 110, 112, 114, 116, 118, 120, 122, 124, 126, 128 is hingedly connected to two adjacent polyhedrons by two of the respective joints 146, 148, 150, 152, 154, 156, 158, 160, 162, 164, 166, 168. In any embodiment, each polyhedron may have at least four facets.

Eight of the twelve polyhedrons 106, 108, 112, 114, 118, 120, 124, 126 are a first type of tetrahedron A1, A2 having a first geometry described in FIG. 1B and FIG. 1C (tetrahedron types A1 and A2 are mirror images of each other). The remaining four polyhedrons 110, 116, 122, 128 are a second type of tetrahedron having a different second geometry described in FIG. 1B and FIG. 1C (tetrahedron types B1 and B2 are mirror images of each other). As used herein, two or more polyhedrons may be of a single type of polyhedron (i.e., either first type or second type) if they are congruent with each other, notwithstanding any difference in surface treatment. For example, two mirror image polyhedrons are congruent, and therefore can both be a first type or a second type polyhedron.

The polyhedrons 106, 108, 110, 112, 114, 116, 118, 120, 122, 124, 126, 128 are hingedly connected in a repeating alternating sequence consisting of two of the first type, one of the second type, two of the first type, and one of the second type. Restated, if the first type of polyhedrons are represented as type “A1” and “A2”, which are mirror images of each other, and the second type of polyhedrons are represented as type “B1” and “B2”, which are mirror images of each other, then the polyhedrons 106, 108, 110, 112, 114, 116, 118, 120, 122, 124, 126, 128 are connected in the following sequence, beginning with polyhedron 106 shown on the left side of FIG. 1A: A1, A2, B1, A2, A1, B2, A1, A2, B1, A2, A1, B2. Accordingly, the transformational display device 102 includes eight of the first type of polyhedrons A1/A2 and four of the second type of polyhedrons B1/B2.

FIG. 1B shows the geometries of the first type of polyhedrons A1/A2 and the second type of polyhedrons B1/B2 of the transformational display device 102. The relative scales and the relationship between the side lengths of each of the polyhedrons of the first type A1/A2 and the second type B1/B2 are set forth in the legend shown in FIG. 1C. The sides illustrated in a solid line pattern have a length of one unit, which may be scaled up or down in different embodiments. Regardless of the numerical value of the solid line pattern unit, the relative relationships between the different sides remain constant between different embodiments. Restated, regardless of the numerical value of the solid line pattern length, sides illustrated in the long dashed-short dashed line pattern have a side length equal to √(2)(unit length) (i.e., the square root of two times the unit length), sides illustrated in the dashed line pattern have a side length equal to √(3)(unit length) (i.e., the square root of three times the unit length), and sides illustrated in the dot-dot-dashed line pattern have a side length equal to 2(unit length).

FIG. 1B schematically represents the geometry of the first type of polyhedron A1/A2. As shown the polyhedron A1/A2 is a tetrahedron with four facets 130, 132, 134, 136 and six edges. The relative lengths of each edge are provided in the legend shown in FIG. 4C. Two of the edges have an edge length of one unit (solid line pattern), two of the edges have an edge length of √(2) units (long dashed-short dashed line pattern), one of the edges has an edge length of √(3) units, and one of the edges has a length of 2 units. As a result of the edge length relationships, all of the facets 130, 132, 134, 136 are right triangles, and the second facet 132 and the third facet 134 are isosceles triangles.

FIG. 1B also schematically represents the geometry of the second type of polyhedron B1/B2. As shown the polyhedron B1/B is a tetrahedron with four facets 138, 140, 142, 144 and six edges. The relative lengths of each edge are provided in the legend shown in FIG. 1C. Two of the edges have an edge length of 1 unit (solid line pattern), two of the edges have an edge length of √(2) units (long dashed-short dashed line pattern), one of the edges has an edge length of √(3) units, and one of the edges has a length of 2 units. As a result of the edge length relationships, all four of the facets 138, 140, 142, 144 are right triangles. Moreover, the first facet 138 and the fourth facet 144 are congruent, and the second facet 140 and the third facet 142 are also congruent.

Comparing the first polyhedron type A1/A2 with the second polyhedron type B1/B2 in FIG. 1B, it is evident that the second facet 132 of the first type of polyhedron A1/A2 is congruent with the second facet 140 and the third facet 142 of the second type of polyhedron B1/B2. This congruence, together with the other edge relationships of the two types of polyhedron A1/A2, B1/B2, as well as the ordered sequence described above of the first type A1/A2 and second type B1/B2 of polyhedron in the continuous loop arrangement 104, and the placement of the joints 146, 148, 150, 152, 154, 156, 158, 160, 162, 164, 166, 168, enables the second facet 132 of one of the first type of polyhedrons A1/A2 to abut either the second facet 140 or the third facet 142 of one of the second type of polyhedrons B1/B2, thereby forming a configuration having three orthogonal faces. Such a configuration having three orthogonal faces is useful for the construction of various parallelepiped and pyramidal configurations, such as the display configurations 404, 406, 408, 604, 606, 608, 804, 806, 808 shown in FIG. 4, FIG. 6, and FIG. 8.

FIG. 2 schematically illustrates surface features of another exemplary transformation display device 202 incorporating optional magnetic features. As shown, the transformational display device 202 is of the same type as the transformational display device 102 described above with reference to FIG. 1A-FIG. 1C, although it is to be appreciated that the magnetic features shown in FIG. 2 may be applied to transformational display devices having a variety of different shape configurations. The transformational display device 202 includes twelve polyhedrons 204 of the first type A1/A2 and the second type B1/B2 described above. According to an example, each of the polyhedrons 204 includes at least one magnet 210, 212 disposed proximal to at least one facet 206, 208 thereof. The magnets 210, 212 are configured to stabilize the polyhedrons 204 in the various display configurations. The magnets 210, 212 may also be arranged and positioned to provide an appealing tactile feedback when the transformational display device 202 achieves any one of the various display configurations. As used herein, “magnet” includes both permanent magnets (e.g., ferrite magnets) and temporary magnets (e.g., a ferrous wafer having a magnetic field following close contact with a permanent magnet).

One representative and non-limiting polarity arrangement will now be described. The magnets 210 represented with a plus symbol (“+”) in the positive magnetic facets 206 in FIG. 2 indicate magnets 210 having a positive magnetic polarity and the magnets 212 represented with a minus symbol (“−”) in the negative magnetic facets 208 indicate magnets 212 having a negative magnetic polarity. In particular, at least one magnet 210, 212 is provided on each polyhedron 204 at a location and with a polarity selected to magnetically couple with at least one magnet 212, 210 of an opposite polarity positioned on another polyhedron 204, e.g., when the transformational display device 202 is manipulated into the different display configurations.

According the example illustrated in FIG. 2, each of the polyhedrons 204 has at least one positive magnet 210 disposed proximal to each positive magnetic facet 206 and one negative magnet 212 disposed proximal to each negative magnetic facet 208, i.e., four magnets 210, 212 per polyhedron 204. In the illustrated example, each magnet 210, 212 is embedded in each facet 206, 208, e.g., in a recess formed in the facet itself (either on the outer surface or inner surface). In other examples, each magnet 210, 212 may be disposed within an interior cavity of each polyhedron 204 and positioned sufficiently near the relevant facet 206, 208 such that the magnetic field of the magnet extends through the facet 206, 208. For example, in some examples, each magnet 210, 212 may be held within in a groove, slot, and/or track disposed within the cavity. In some other examples, one or more of the magnets 210, 212 may be positioned within a cradle, such as a cradle disposed near a vertex of the edges of the polyhedron 204, such that the magnetic field from the magnet 210, 212 extends through more than one facet 206, 208 of the polyhedron 204.

According to the example of FIG. 2, in order to facilitate magnetic coupling of the polyhedrons 204, each polyhedron 204 includes magnets 210, 212 all of a single polarity (“+” or “−”) and the adjoining polyhedron 204 includes magnets 212, 210 all of the opposite polarity (“−” or “+”) and so forth in an alternating fashion throughout the plurality of polyhedrons 204.

According to alternative examples, one or more of the polyhedrons 204 has less than four magnets, for example one, two, or three magnets 210, 212. According to another alternative example, each of the polyhedrons 204 may include a single magnet 210, 212 embedded centrally within the polyhedron 204.

It is to be appreciated that the magnets 210, 212 may be of any type suitable for stabilizing and maintaining the polyhedrons 204 in the various display configurations, while also allowing for manipulation and rearrangement of the polyhedrons with respect to one another. According to an example, all of the magnets 210, 212 are permanent magnets that produce a constant magnetic field even in the absence of an inducing field or current. According to another example, some of the magnets 210, 212 may be temporary magnets that only exhibit magnetic properties when placed in proximity to an inducing magnetic field, such as one provided by a permanent magnet, or a current.

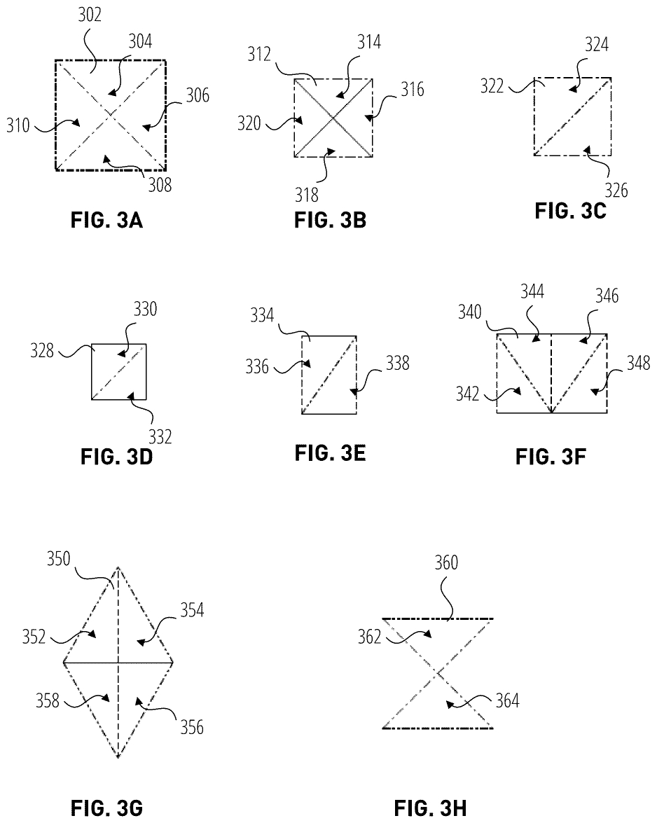

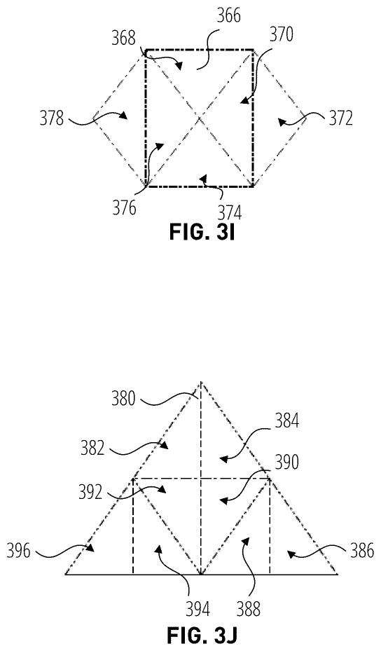

FIG. 3A-FIG. 3J schematically depict various exemplary planar display surfaces, each comprising adjacent and coplanar facets of at least two polyhedrons. Planar display surfaces 302, 312, 322, 328, 334, 340, 350, 360, 366, 380 can be achieved through manipulation of the transformational display device 102, described above with reference to FIG. 1A-FIG. 1C, into the different display configurations. FIG. 3A-FIG. 3J show the edge lengths of the facets forming of the planar display surfaces 302, 312, 322, 328, 334, 340, 350, 360, 366, 380 in the same patterns shown in the legend of FIG. 1C, therefore it is to be understood that the planar display surfaces 302, 312, 322, 328, 334, 340, 350, 360, 366, 380 shown in FIG. 3A-FIG. 3J have relative dimensions that can be determined according to the legend shown in FIG. 1C.

FIG. 3A shows a large square planar display surface 302 made up of four adjacent and coplanar display facets 304, 306, 308, 310 of four of the plurality of polyhedrons. The large square planar display surface 302 has four sides shown in the dot-dot-dashed line pattern indicating that the sides of the planar display surface 302 have lengths that are all equal to 2 units.

FIG. 3B shows a first medium square planar display surface 312 made up of four adjacent and coplanar display facets 314, 316, 318, 320 of four of the plurality of polyhedrons. The medium square planar display surface 312 has four sides shown in the long dashed-short dashed line pattern indicating that the sides of the planar display surface 312 have lengths that are all equal to √(2) units.

As used herein, a “medium” planar display surface transformational display device has a greater surface area than a “small” planar display surface of a same or similar shape device and a lesser surface area than a “large” planar display surface of a same or similar shape, of the same transformational display device. A “small” planar display surface has a lesser surface area than another planar display surface of a same or similar shape of the same transformational display device. A “large” planar display surface has a larger surface area than another planar display surface of a same or similar shape of the same transformational display device.

FIG. 3C shows a second medium square planar display surface 322 made up of two adjacent and coplanar display facets 324, 326 of two of the plurality of polyhedrons. The medium square planar display surface 324 has four sides shown in the long dashed-short dashed line pattern indicating that the sides of the planar display surface 322 have lengths that are all equal to √(2) units.

FIG. 3D shows a small square planar display surface 328 made up of two adjacent and coplanar display facets 330, 332 of two of the plurality of polyhedrons. The small square planar display surface 328 has four sides shown in the solid line pattern indicating that the sides of the planar display surface 328 have lengths that are all equal to 1 unit.

FIG. 3E shows a small non-square rectangular planar display surface 334 made up of two adjacent and coplanar display facets 336, 338 of two of the plurality of polyhedrons. The small rectangular planar display surface 334 has two opposing sides shown in the solid line pattern and two opposing sides shown in the dashed line pattern indicating that the sides of the planar display surface 334 have lengths that are equal to 1 unit and √(3) units, respectively.

FIG. 3F shows a large non-square rectangular planar display surface 340 made up of four adjacent and coplanar display facets 342, 344, 346, 348 of four of the plurality of polyhedrons. The large rectangular planar display surface 340 has two opposing sides shown in the dashed line pattern and two opposing sides made up of two edge lengths shown in the solid line pattern indicating that the sides of the planar display surface 340 surface have lengths that are equal to √(3) units and 2 units (i.e., 1 unit times 2), respectively. According to an example, the large rectangular planar display surface 340 is comprised of two small rectangular planar display surfaces 334, shown in FIG. 3E, arranged side-by-side.

FIG. 3G shows a non-square rhomboidal planar display surface 350 made up of four adjacent and coplanar display facets 352, 354, 356, 358 of four of the plurality of polyhedrons. The rhomboidal planar display surface 350 has four sides shown in the dot-dot-dashed line pattern indicating that the sides of the planar display surface 350 have lengths that are all equal to 2 units.

FIG. 3H shows an hour-glass shaped planar display surface 360 made up of two adjacent and coplanar display facets 362, 364 of two of the plurality of polyhedrons meeting at a point. The hour-glass shaped planar display surface 360 has two opposing sides shown in the dot-dot-dashed line pattern indicating that the opposing sides of the planar display surface 360 have lengths that are equal to 2 units and two crossing sides made up of two edge lengths shown in the long dashed-short dashed line pattern indicating that the crossing sides of the planar display surface 360 have lengths that are equal to 2√(2) units (i.e., √(2) units times 2). According to an example, the hour-glass shaped planar display surface 360 is made up of two opposing facets 362, 364 that may also form part of a large square planar display surface 302 shown in FIG. 3A.

FIG. 3I shows a hexagonal planar display surface 366 made up of six adjacent and coplanar display facets 368, 370, 372, 374, 376, 378 of six of the plurality of polyhedrons. The hexagonal planar display surface 366 has two opposing sides in the dot-dot-dashed line pattern and two sets of opposing sides in the long dashed-short dashed line pattern, indicating that the sides of the planar display surface 366 have lengths that are equal to 2 units and √(2) units, respectively. According to an example, the hexagonal planar display surface 366 is made up of a large square planar display surface 302 shown in FIG. 3A with two additional facets 372, 378 extending from opposing sides thereof.

FIG. 3J shows a triangular planar display surface 380 made up of eight adjacent and coplanar display facets 382, 384, 386, 388, 390, 392, 394, 396 of eight of the plurality of polyhedrons. The triangular planar display surface 380 has two sides each made up of two edge lengths shown in the dot-dot-dashed line pattern and one side made up of four edge lengths shown in the solid line pattern, indicating that the sides of the planar display surface 380 have lengths that are all equal to 4 units (i.e., 2 units times 2 and 1 unit times 4) in order to form an equilateral triangle.

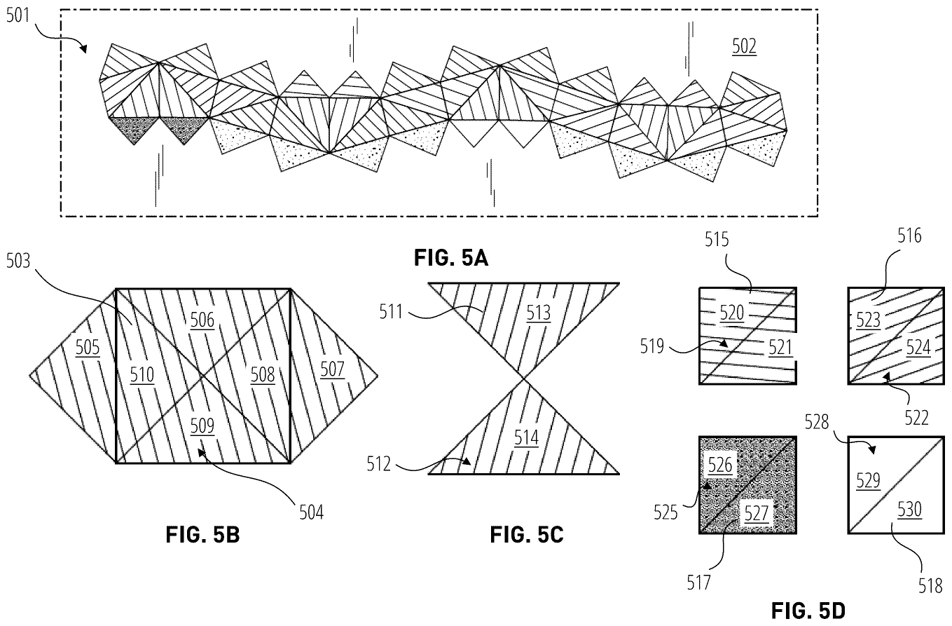

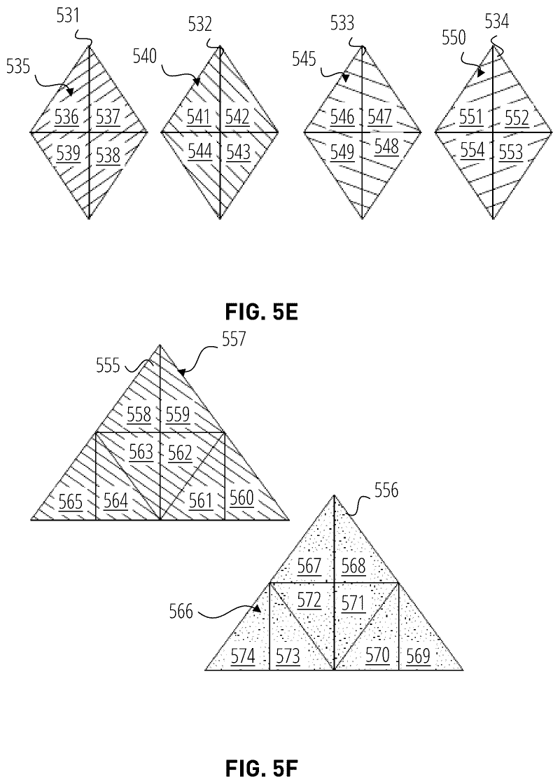

FIG. 4 illustrates a representative transformational display device 402 according to an example of the present disclosure. According to the example, the transformational display device 402 has the same structure and geometries as the transformational display device 102 discussed above with reference to FIG. 1A-FIG. 1C. As shown, the transformational display device 402 is configurable between different display configurations 404, 406, 408 corresponding to geometric shapes in which one or more planar display surfaces 410, 412, 414 are formed. The transformational display device 402 has a graphical surface treatment as described below with respect to FIG. 5A-FIG. 5F.

More particularly, the transformational display device 402 is configurable to at least one display configuration 404 made up of two hingedly connected triangles or pyramids 422 arranged with respective faces thereof in an abutting engagement, thus forming a non-square rhomboidal planar display surface 410 contiguously exhibiting a first graphical image 416. The transformational display device 402 is also configurable to at least one display configuration 406 also made up of two hingedly connected pyramids 422 rotated apart about their hinged connection to form a hexagonal planar display surface 412 contiguously exhibiting a second graphical image 418. The transformational display device 402 is still further configurable to at least one display configuration 408 made up of the two hingedly connected pyramids 422 rotated apart about their hinged connection to form a triangular planar display surface 414 contiguously exhibiting a third graphical image 420.

FIG. 5A-FIG. 5F schematically depict an exemplary physical graphical surface treatment 501 that may be applied to a transformational display device, including the transformational display device 402 shown in FIG. 4, such that the transformational display device 402 contiguously exhibits the multiple graphical images 416, 418, 420 within the planar display surfaces 410, 412, 414, as discussed above.

FIG. 5A schematically shows the graphical surface treatment 501 as it may be applied to each of the display facets distributed among the plurality of facets of each of the polyhedrons of the transformational display device 402. FIG. 5B-FIG. 5F schematically show the possible planar display surfaces 503, 511, 515, 516, 517, 518, 531, 532, 533, 534, 555, 556, contiguously exhibiting up to twelve graphical images 504, 512, 519, 522, 525, 528, 535, 540, 545, 550, 557, 566.

As shown in FIG. 5A, the graphical surface treatment 501 exhibits multiple sets of partial image segments (to be described below) that are formed by dividing each of the graphical images 504, 512, 519, 522, 525, 528, 535, 540, 545, 550, 557, 566 into at least two parts that correspond to the display facets forming the planar display surfaces 503, 511, 515, 516, 517, 518, 531, 532, 533, 534, 555, 556. Each image segment includes a portion of one of the graphical images 504, 512, 519, 522, 525, 528, 535, 540, 545, 550, 557, 566. As shown in FIG. 5A-FIG. 5F, the image segments formed from each of the graphical images 504, 512, 519, 522, 525, 528, 535, 540, 545, 550, 557, 566 are provided with surface patterns unique to the respective graphical images 504, 512, 519, 522, 525, 528, 535, 540, 545, 550, 557, 566. Accordingly, FIG. 5A-FIG. 5F illustrate the spatial relationships between the various image segments of each set when divided apart on the graphical surface treatment 501 as it is applied to the facets of the transformational display device 402 in the loop arrangement 104, shown in FIG. 1A, and when arranged adjacent to and coplanar with each other in the planar display surfaces 503, 511, 515, 516, 517, 518, 531, 532, 533, 534, 555, 556.

It is to be appreciated that the surface patterns shown in FIG. 5A-FIG. 5F are provided for ease of illustration and understanding of the spatial relationships between the image segments in each set. According to an example, at least a portion of the image segments shown in FIG. 5A-FIG. 5F are partial image segments converted from a complete graphical image and/or that combine to form an amalgamated graphical image made up of different and non-repeating partial image segments. According to a particular example, all of the partial image segments are different and non-repetitive. In other words, the partial image segments of some or all of the graphical images are non-repetitive and do not exhibit a repetitive pattern or a portion of a pattern that may form a repeating chain of pattern units. FIG. 4 provides examples of graphical images 416, 418, 420 made up of different and non-repetitive partial image segments.

As shown in FIG. 5B, the graphical surface treatment 501 is configured so that a first graphical image 504 made up of a set of image segments 505, 506, 507, 508, 509, 510 is contiguously exhibited within a hexagonal planar display surface 503 corresponding to the hexagonal planar display surface 412 formed in the two-pyramid display configuration 406 shown in FIG. 4 and the hexagonal planar display surface 366 shown in FIG. 3I.

As shown in FIG. 5C, the graphical surface treatment 501 is configured so that a second graphical image 512 made up of a set of image segments 513, 514 is contiguously exhibited within an hour-glass shaped planar display surface 511 corresponding to the hour-glass shaped planar display surface 360 shown in FIG. 3H. According to an example, the hour-glass shaped planar display surface 511 may be formed when the transformational display device 402 is in another two-pyramid display configuration of the same shape as the two-pyramid display configuration 406 shown in FIG. 4. In other words, the geometric shape of the two-pyramid display configuration 406 can be achieved through different transformations or rearrangements of the polyhedrons of the transformational display device 402 and thus different planar display surfaces of the same size and shape can be formed.

As shown in FIG. 5D, the graphical surface treatment 501 is configured so that a third graphical image 519 made up of a set image segments 520, 521, a fourth graphical image 522 made up of a set image segments 523, 524, a fifth graphical image 525 made up of a set image segments 526, 527, and a sixth graphical image 528 made up of a set of image segments 529, 530 are contiguously exhibited within respective small square planar display surfaces 515, 516, 517, 518 corresponding to the small square planar display surface 328 shown in FIG. 3D. According to an example, the small square planar display surfaces 515, 516, 517, 518 are formed as the top and bottom surfaces of a rectangular parallelepiped display configuration of the transformational display device 402 with two small square planar display surfaces 515, 516, 517, 518 arranged coplanar and side-by-side on each of the top and bottom sides of the rectangular parallelepiped. Further, the rectangular parallelepiped may be comprised of two smaller rectangular parallelepipeds that are hingedly connected.

As shown in FIG. 5E, the graphical surface treatment 501 is configured so that a seventh graphical image 535 made up of a set of image segments 536, 537, 538, 539, an eighth graphical image 540 made up of a set of image segments 541, 542, 543, 544, a ninth graphical image 545 made up of a set image segments 546, 547, 548, 549, and a tenth graphical image 550 made up of a set of image segments 551, 552, 553, 554 are contiguously exhibited within respective non-square rhomboidal planar display surfaces 531, 532, 533, 534 corresponding to the non-square rhomboidal planar display surface 410 formed in the abutting pyramid display configuration 404 shown in FIG. 4 and the non-square rhomboidal planar display surface 350 shown in FIG. 3G. According to an example, the non-square rhomboidal planar display surfaces 531, 532, 533, 534 may be formed when the transformational display device 402 is in one of multiple abutting pyramid display configurations of the same shape as the abutting pyramid display configuration 404 shown in FIG. 4. In other words, the geometric shape of the abutting pyramid display configuration can be achieved through different transformations or rearrangements of the polyhedrons of the transformational display device 402 and thus different planar display surfaces of the same size and shape can be formed.

As shown in FIG. 5F, the graphical surface treatment 501 is configured so that an eleventh graphical image 557 made up of a set of image segments 558, 559, 560, 561, 562, 563, 564, 565 and a twelfth graphical image 566 made up of a set of image segments 567, 568, 569, 570, 571, 572, 573, 574 are contiguously exhibited within respective triangular planar display surfaces 555, 556 corresponding to the triangular planar display surface 414 formed in the two-pyramid display configuration 408 shown in FIG. 4 and the triangular planar display surface 380 shown in FIG. 3J. According to an example, the triangular planar display surfaces may be formed when the transformational display device 402 is in one of multiple two-pyramid display configurations of the same shape as the two-pyramid display configuration 408 shown in FIG. 4. In other words, the geometric shape of the two-pyramid display configuration can be achieved through different transformations or rearrangements of the polyhedrons of the transformational display device 402 and thus different planar display surfaces of the same shape and size can be formed.

According to an example, the graphical surface treatment 501 may comprise a decal, an adhesive-backed label, a printed layer of ink, a printed layer of paint, a printed layer of dye, an etching, an engraving, an embossment, or an inscription.

According to another example, the graphical surface treatment 501 may comprise one or more decals or adhesive-backed labels, e.g., disposed on a substrate 502.

According to the example shown in FIG. 5A-FIG. 5F, the graphical surface treatment 501 contains image segments corresponding to all of the facets of the plurality of polyhedrons of the transformational display device 402 and is applied to each of the facets. Accordingly, each of the plurality of facets of each polyhedron is a display facet exhibiting an image segment. It is to be appreciated that graphical surface treatment 501 may be distributed on the plurality of facets of the polyhedrons of the transformational display device 402 in such a manner that not all of the facets have the graphical surface treatment 501 applied thereto. For instance, the graphical surface treatment 501 may contain fewer graphical images and, as a result, some of the facets of the plurality of polyhedrons may be left blank. According to another example, each polyhedron includes at least one display facet having the graphical surface treatment 501 applied thereto.

The graphical surface treatment 501 is shown as a single contiguous arrangement of image segments in FIG. 5A. However, in any embodiment, the graphical surface treatment 501 may include a plurality of graphical surface treatment portions, e.g., a first graphical surface treatment portion bearing at least one partial image segment of a first graphical image, and a second graphical surface treatment portion bearing at least one partial image segment of a (different) second graphical image. Each graphical surface treatment portion may extend across one, two, or more facets. Any graphical surface treatment portion extending across two or more facets may form a joint, e.g., a living hinge.

According to the example of FIG. 4-FIG. 5F, the transformational display device 402 is configurable between nine different display configurations (i.e., one rectangular parallelepiped display configuration, four abutting pyramid display configurations 404, two two-pyramid display configurations 406, and two two-pyramid display configurations 408) in which the twelve planar display surfaces 503, 511, 515, 516, 517, 518, 531, 532, 533, 534, 555, 556 are formed such that twelve graphical images 504, 512, 519, 522, 525, 528, 535, 540, 545, 550, 557, 566 may be contiguously exhibited through manipulation and rearrangement of the transformational display device 402.

Accordingly, the graphical surface treatment 501 enables a plurality of graphical images (here, twelve) to be divided into partial image segments, distributed across a graphical surface treatment, and applied to a transformational display device, in such a way that a contiguous portion of each image is displayed on each planar display surface.

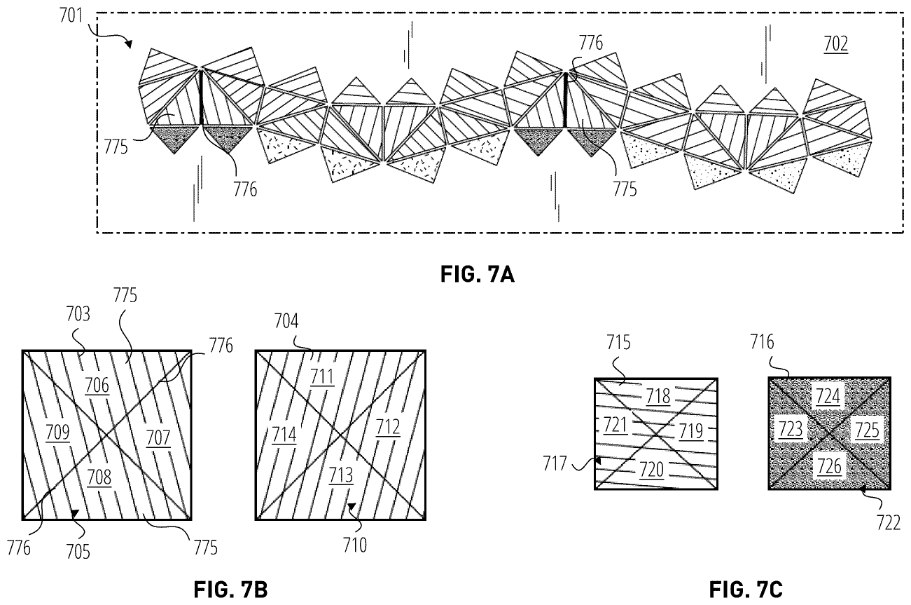

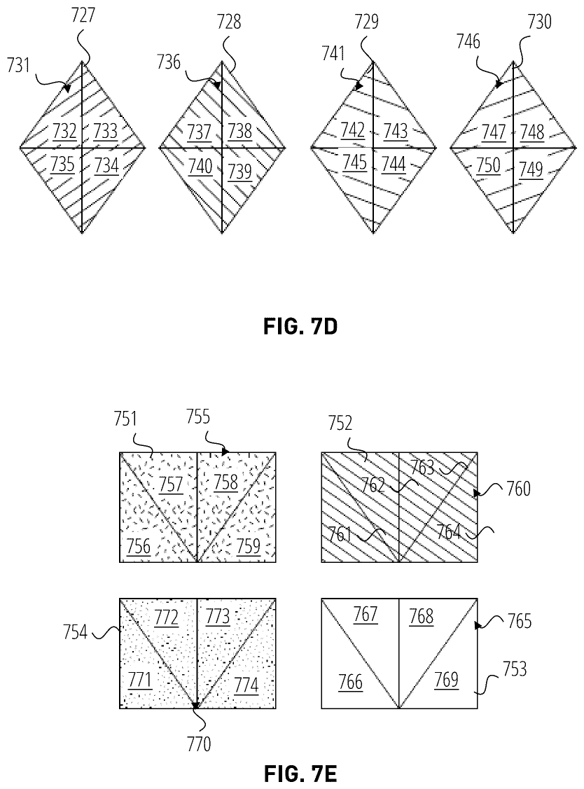

FIG. 6 illustrates a transformational display device 602 according to another example of the present disclosure. According to the example, the transformational display device 602 has the same structure and geometries as the transformational display device 102 discussed above with reference to FIG. 1A-FIG. 1C. As shown, the transformational display device 602 is configurable between different display configurations 604, 606, 608 corresponding to geometric shapes in which one or more planar display surfaces 610, 612, 614 are formed. The transformational display device 602 has a graphical surface treatment as described below with respect to FIG. 7A-FIG. 7E.

More particularly, the transformational display device 602 is configurable to at least one display configuration 604 made up of two hingedly connected pyramids 422 (shown in FIG. 4) arranged with respective faces thereof in an abutting engagement, thus forming a non-square rhomboidal planar display surface 610 contiguously exhibiting a first graphical image 616. The transformational display device 602 is also configurable to at least one display configuration 606 also made up of two hingedly connected pyramids rotated apart about their hinged connection to form a large square planar display surface 612 contiguously exhibiting a second graphical image 618.

The transformational display device 602 is still further configurable to at least one rectangular parallelepiped display configuration 608 forming a large non-square rectangular display surface 614 contiguously exhibiting a third graphical image 620. The rectangular parallelepiped may be comprised of two smaller rectangular parallelepipeds that are hingedly connected.

FIG. 7A-FIG. 7E schematically depict a graphical surface treatment 701 that may be applied to a transformational display device, including the transformational display device 602 shown in FIG. 6, such that the transformational display device 602 contiguously exhibits the multiple graphical images 616, 618, 620 within the planar display surfaces 610, 612, 614, as discussed above. FIG. 7A schematically shows the graphical surface treatment 701 as it may be applied to each of the display facets distributed among the plurality of facets of each of the polyhedrons of the transformational display device 602. FIG. 7B-FIG. 7E schematically show the possible planar display surfaces 703, 704, 715, 716, 727, 728, 729, 730, 751, 752, 753, 754, contiguously exhibiting up to twelve graphical images 705, 710, 717, 722, 731, 736, 741, 746, 755, 760, 765, 770.

As shown in FIG. 7A, the graphical surface treatment 701 exhibits multiple sets of partial image segments (to be described below) that are formed by dividing each of the graphical images 710, 712, 718, 720, 730, 732, 734, 736, 746, 748, 750, 752 into a plurality of partial image segments that correspond to the display facets forming the planar display surfaces 706, 708, 714, 716, 722, 724, 726, 728, 738, 740, 742, 744. Each image segment includes a portion of one of the graphical images 710, 712, 718, 720, 730, 732, 734, 736, 746, 748, 750, 752. As shown in FIG. 7A-FIG. 7E, the image segments formed from each of the graphical images 710, 712, 718, 720, 730, 732, 734, 736, 746, 748, 750, 770 are provided with surface patterns unique to the respective graphical images 705, 710, 717, 722, 731, 736, 741, 746, 755, 760, 765, 770. Accordingly, FIG. 7A-FIG. 7E illustrate the spatial relationships between the various image segments of each set when divided apart on the graphical surface treatment 701 as it is applied to the facets of the transformational display device 602 in the loop arrangement 104, shown in FIG. 1A, and when arranged adjacent to and coplanar with each other in the planar display surfaces 703, 704, 715, 716, 727, 728, 729, 730, 751, 752, 753, 754.

It is to be appreciated that the surface patterns shown in FIG. 7A-FIG. 7E are provided for ease of illustration and understanding of the spatial relationships between the image segments in each set. According to an example, at least a portion of the image segments shown in FIG. 7A-FIG. 7E are partial image segments converted from a complete graphical image and/or that combine to form an amalgamated graphical image made up of different and non-repeating partial image segments. According to a particular example, all of the partial image segments are different and non-repetitive. In other words, the partial image segments of some or all of the graphical images are non-repetitive and do not exhibit a repetitive pattern or a portion of a pattern that may form a repeating chain of pattern units. FIG. 6 provides examples of graphical images 616, 618, 620 made up of different and non-repetitive partial image segments.

The graphical surface treatment 701 is shown as an arrangement of graphical surface treatment portions, e.g., a first graphical surface treatment portion bearing at least one partial image segment of a first graphical image, and a second graphical surface treatment portion bearing at least one partial image segment of a (different) second graphical image. Each graphical surface treatment portion extends across one facet in FIG. 7A. In any embodiment, any graphical surface treatment portion may extend across two or more facets and may form a joint, e.g., a living hinge.

As shown in FIG. 7B, the graphical surface treatment 701 is configured so that a first graphical image 705, made up of a set of image segments 706, 707, 708, 709, and a second graphical image 710, made up of a set of image segments 711, 712, 713, 714, are contiguously exhibited within respective large square planar display surfaces 703, 704 corresponding to the large square planar display surface 612 formed in the two-pyramid display configuration 606 shown in FIG. 6 and the large square planar display surface 302 shown in FIG. 3A. According to an example, the large square planar display surfaces 703, 704 may be formed when the transformational display device 602 is in one of multiple two-pyramid display configurations of the same shape as the two-pyramid display configuration 606 shown in FIG. 6. In other words, the geometric shape of the two-pyramid display configuration can be achieved through different transformations or rearrangements of the polyhedrons of the transformational display device 602 and thus different planar display surfaces of the same size and shape can be formed.

As shown in FIG. 7C, the graphical surface treatment 701 is configured so that a third graphical image 717 made up of a set of image segments 718, 719, 720, 721 and a fourth graphical image 722 made up of a set of image segments 723, 724, 725, 726 are contiguously exhibited within respective medium square planar display surfaces 715, 716 corresponding to the medium square planar display surface 312 shown in FIG. 3B. According to an example, the medium square planar display surfaces 715, 716 are formed as the top and bottom surfaces of a cuboid display configuration.

As shown in FIG. 7D, the graphical surface treatment 701 is configured so that a fifth graphical image 731 made up of a set of image segments 732, 733, 734, 735, a sixth graphical image 736 made up of a set of image segments 737, 738, 739, 740, a seventh graphical image 741 made up of a set of image segments 742, 743, 744, 745, and an eighth graphical image 746 made up of a set of image segments 747, 748, 749, 750 are contiguously exhibited within respective non-square rhomboidal planar display surfaces 727, 728, 729, 730 corresponding to the non-square rhomboidal planar display surface 610 formed in the abutting pyramid display configuration 604 shown in FIG. 6 and the non-square rhomboidal planar display surface 350 shown in FIG. 3G. According to an example, the non-square rhomboidal planar display surfaces 722, 724, 726, 728 may be formed when the transformational display device 602 is in one of multiple abutting pyramid display configurations of the same shape as the abutting pyramid display configuration 604 shown in FIG. 6. In other words, the geometric shape of the abutting pyramid display configuration can be achieved through different transformations or rearrangements of the polyhedrons of the transformational display device 602 and thus different planar display surfaces of the same size and shape can be formed.

As shown in FIG. 7E, the graphical surface treatment 701 is configured so that a ninth graphical image 755 made up of a set of image segments 756, 757, 758, 759, a tenth graphical image 760 made up of a set of image segments 761, 762, 763, 764, an eleventh graphical image 765 made up of a set of image segments 766, 767, 768, 769, and a twelfth graphical image 770 made up of a set of image segments 771, 772, 773, 774 are contiguously exhibited within respective large non-square rectangular planar display surfaces 751, 752, 753, 754 corresponding to the large non-square rectangular planar display surface 614 formed in the rectangular parallelepiped display configuration 608 shown in FIG. 6 and the large non-square rectangular planar display surface 340 shown in FIG. 3F. According to an example, the large non-square rectangular planar display surfaces 738, 740, 742, 744 may be formed when the transformational display device 602 is in one of multiple rectangular parallelepiped display configurations of the same shape as the rectangular parallelepiped display configuration 608 shown in FIG. 6. In other words, the geometric shape of the rectangular parallelepiped display configuration can be achieved through different transformations or rearrangements of the polyhedrons of the transformational display device 602 and thus different planar display surfaces of the same size and shape can be formed. According to an example, the rectangular parallelepiped display configuration 608 is formed from two smaller, hingedly connected rectangular parallelepipeds. The four large non-square rectangular display surfaces 738, 740, 742, 744 may comprise two sets of opposing lateral surfaces of the rectangular parallelepipeds formed when the smaller rectangular parallelepipeds are rotated with respect to each other between two abutting positions.

According to an example, the graphical surface treatment 701 shown in FIG. 7A may comprise a plurality of graphical surface treatment portions born on substrates 775 having the sets of image segments imprinted thereon, which are then applied to the display facets of the transformational display device 602. The substrates 775 may be cut from a common stock substrate 702. According to the example, the plurality of substrates 775 comprise a plurality of decals or adhesive-backed labels configured to be adhered to the display facets. According to a particular example, the graphical surface treatment 701 may include twenty-four substrates 775 having the twelve sets of image segments imprinted thereon.

As shown, any one of the substrates 775 may have two or more image segments imprinted thereon and the substrates 775 may be applied to two adjoining display facets of two adjoining polyhedrons of the transformational display device 602. In other words, the substrates 775 may be configured to bridge the joint between two adjoining polyhedrons. As shown in FIG. 7B, the image segments 706, 707 imprinted on one of the substrates 775 may be taken from a common set of image segments and include portions of the same graphical image 705 and thus form a portion of one of the planar display surfaces 703. As shown in FIGS. 7A and 7B, the graphical image 705 is made up of a set of image segments 706, 707, 708, 709 that is imprinted on two separate substrates 775 (two image segments per substrate 775) applied to display facets that are non-adjoining when the transformational display device 602 is in the loop arrangement 104 shown in FIG. 1A.

According to an example, one or more of the substrates 775 may incorporate joints 776, e.g., living hinges, that form at least part of the structure of the joints 146, 148, 150, 152, 154, 156, 160, 162, 164, 166, 168 of the transformational display device 102 described above with reference to FIG. 1A-FIG. 1C. Accordingly, the joint between the adjoining polyhedrons having a substrate 775 applied thereto may comprise the substrate 775 itself, alone or in combination with other structures. According to another example, the joint between the adjoining polyhedrons comprises two substrates 775 applied to opposing adjoining display facets of the two adjoining polyhedrons. As shown in FIG. 7A and FIG. 7B, the image segments 706, 707, 708, 709 imprinted on the substrates 775 incorporating a joint 776 may be divided along the joint 776.

According to the example of FIG. 6-FIG. 7E, the transformational display device 602 is configurable between nine different display configurations (i.e., one cuboid display configuration, four abutting pyramid display configurations 604, two two-pyramid display configurations 606, and two rectangular parallelepiped display configurations 608) in which the twelve planar display surfaces 703, 704, 715, 716, 727, 728, 729, 730, 751, 752, 753, 754 are formed such that twelve graphical images 710, 712, 718, 720, 730, 732, 734, 736, 746, 748, 750, 770 may be contiguously exhibited through manipulation and rearrangement of the transformational display device 602.

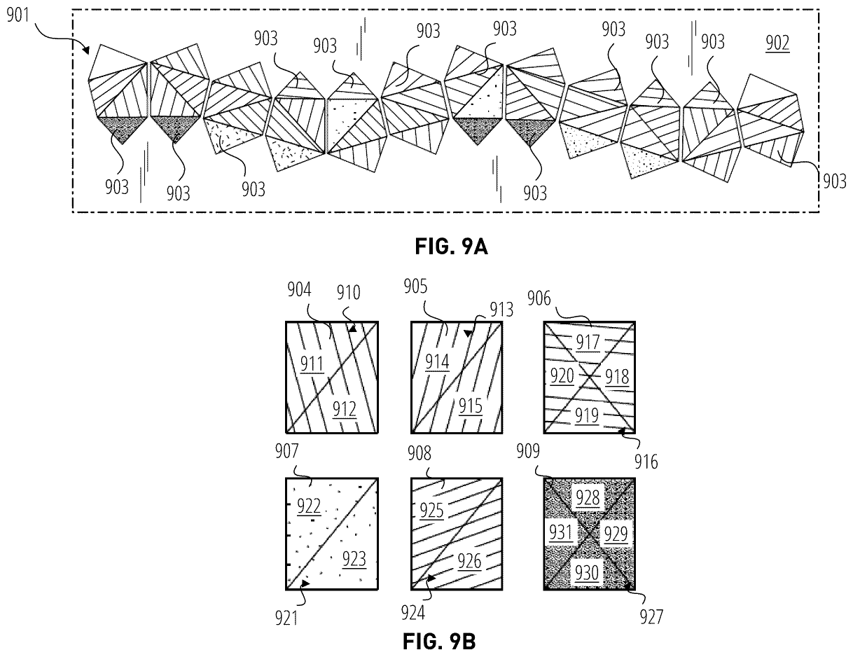

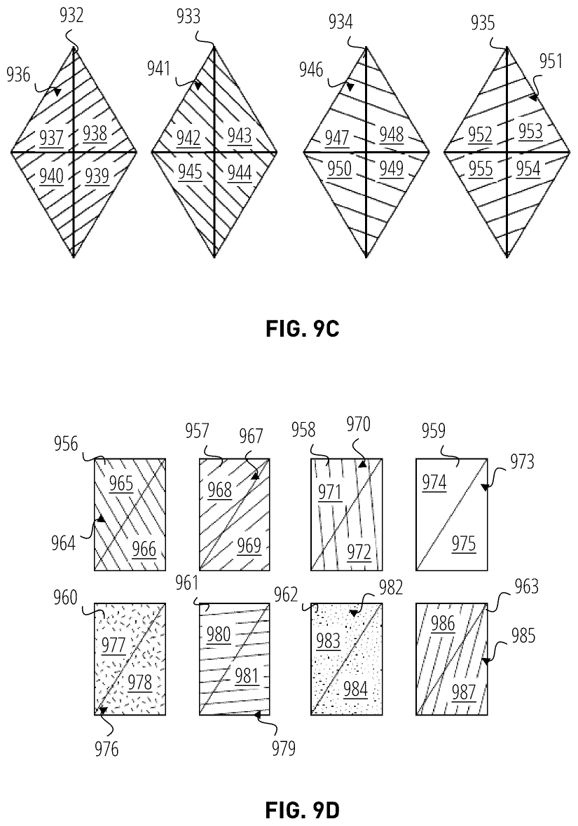

FIG. 8 illustrates a transformational display device 802 according to an example of the present disclosure. According to the example, the transformational display device 802 has the same structure and geometries as the transformational display device 102 discussed above with reference to FIG. 1A-FIG. 1C. As shown, the transformational display device 802 is configurable between different display configurations 804, 806, 808 corresponding to geometric shapes in which one or more planar display surfaces 810, 812, 814, 816 are formed. The transformational display device 802 has a graphical surface treatment as described below with respect to FIG. 9A-FIG. 9D.

More particularly, the transformational display device 802 is configurable to at least one cuboid display configuration 804 forming a medium square planar display surface 810 contiguously exhibiting a first graphical image 818. The transformational display device 802 is further configurable to at least one display configuration 806 made up of two hingedly connected pyramids 422 (shown in FIG. 4) arranged with respective faces thereof in an abutting engagement, thus forming a non-square rhomboidal planar display surface 812 contiguously exhibiting a second graphical image 820. The transformational display device 802 is also configurable to at least one rectangular parallelepiped display configuration 808 forming a first small non-square rectangular planar display surface 814 contiguously exhibiting a third graphical image 822 and a second small non-square rectangular planar display surface 816 contiguously exhibiting a fourth graphical image 824.

FIG. 9A-FIG. 9D schematically depict a graphical surface treatment 901 that may be applied to a transformational display device, including the transformational display device 802 shown in FIG. 8, such that the transformational display device 802 contiguously exhibits the multiple graphical images 818, 820, 822, 824 within the planar display surfaces 810, 812, 814, 816, as discussed above. FIG. 9A schematically shows the graphical surface treatment 901 as it may be applied to each of the display facets distributed among the plurality of facets of each of the polyhedrons of the transformational display device 802. FIG. 9B-FIG. 9D schematically show the possible planar display surfaces 904, 905, 906, 907, 908, 909, 932, 933, 934, 935, 956, 957, 958, 959, 960, 961, 962, 963 contiguously exhibiting up to eighteen graphical images 910, 913, 916, 921, 924, 927, 936, 941, 946, 951, 964, 967, 970, 973, 976, 979, 982, 985.

As shown in FIG. 9A, the graphical surface treatment 901 exhibits multiple sets of image segments (to be described below) that are formed by dividing each of the graphical images 910, 913, 916, 921, 924, 927, 936, 941, 946, 951, 964, 967, 970, 973, 976, 979, 982, 985 into multiple parts that correspond to the display facets forming the planar display surfaces 904, 905, 906, 907, 908, 909, 932, 933, 934, 935, 956, 957, 958, 959, 960, 961, 962, 963. Each image segment includes a portion of one of the graphical images 910, 913, 916, 921, 924, 927, 936, 941, 946, 951, 964, 967, 970, 973, 976, 979, 982, 985. As shown in in FIG. 9A-FIG. 9D, the image segments formed from each of the graphical images 910, 913, 916, 921, 924, 927, 936, 941, 946, 951, 964, 967, 970, 973, 976, 979, 982, 985 are provided with surface patterns unique to the respective graphical images 910, 913, 916, 921, 924, 927, 936, 941, 946, 951, 964, 967, 970, 973, 976, 979, 982, 985. Accordingly, FIG. 9A-FIG. 9D illustrate the spatial relationships between the various image segments of each set when divided apart on the graphical surface treatment 901 as it is applied to the facets of the transformational display device 802 in the loop arrangement 104, shown in FIG. 1A, and when arranged adjacent to and coplanar with each other in the planar display surfaces planar display surfaces 904, 905, 906, 907, 908, 909, 932, 933, 934, 935, 956, 957, 958, 959, 960, 961, 962, 963.

It is to be appreciated that the surface patterns shown in FIG. 9A-FIG. 9D are provided for ease of illustration and understanding of the spatial relationships between the image segments in each set. According to an example, at least a portion of the image segments shown in FIG. 9A-FIG. 9D are partial image segments converted from a complete graphical image and/or that combine to form an amalgamated graphical image made up of different and non-repeating partial image segments. According to a particular example, all of the partial image segments are different and non-repetitive. In other words, the partial image segments of some or all of the graphical images are non-repetitive and do not exhibit a repetitive pattern or a portion of a pattern that may form a repeating chain of pattern units. FIG. 8 provides examples of graphical images 818, 820, 822, 824 made up of different and non-repetitive partial image segments.

As shown in FIG. 9B, the graphical surface treatment 901 is configured so that a first graphical image 910 made up of a set of image segments 911, 912, a second graphical image 913 made up of a set of image segments 914, 915, a third graphical image 916 made up of a set of image segments 917, 918, 919, 920, a fourth graphical image 921 made up of a set of image segments 922, 923, a fifth graphical image 924 made up of a set of image segments 925, 926 and a sixth graphical image 927 made up of a set of image segments 928, 929, 930, 931 are contiguously exhibited within respective medium square planar display surfaces 904, 905, 906, 907, 908, 909. Four of the medium square planar display surfaces 904, 905, 907, 908 correspond to the medium square planar display surface 810 formed in the front surface of the cuboid display configuration 804 shown in FIG. 8 and the medium square planar display surface 322 shown in FIG. 3C. Two of the medium square planar display surfaces 906, 909 correspond to the medium square planar display surface 312 shown in FIG. 3B and may also correspond to the top and bottom surfaces of the cuboid display configuration 804 shown in FIG. 8. According to an example, the medium square planar display surfaces 904, 905, 906, 907, 908, 909 are formed as the six side surfaces of the cuboid display configuration 804 shown in FIG. 8. Adjoining side surfaces of the cuboid display configuration 804 are non-parallel to each other.

As shown in FIG. 9C, the graphical surface treatment 901 is configured so that a seventh graphical image 936 made up of a set of image segments 937, 938, 939, 940, an eighth graphical image 941 made up of a set of image segments 942, 943, 944, 945, a ninth graphical image 946 made up of a set of image segments 947, 948, 949, 950, and a tenth graphical image 951 made up of a set of image segments 952, 953, 954, 955 are contiguously exhibited within respective non-square rhomboidal planar display surfaces 932, 933, 934, 935 corresponding to the non-square rhomboidal planar display surface 812 formed in the abutting pyramid display configuration 806 shown in FIG. 8 and the non-square rhomboidal planar display surface 350 shown in FIG. 3G. According to an example, the non-square rhomboidal planar display surfaces planar display surfaces 932, 933, 934, 935 may be formed when the transformational display device 802 is in one of multiple abutting pyramid display configurations of the same shape as the abutting pyramid display configuration 806 shown in FIG. 8. In other words, the geometric shape of the abutting pyramid display configuration can be achieved through different transformations or rearrangements of the polyhedrons of the transformational display device 802 and thus different planar display surfaces of the same size and shape can be formed.

As shown in FIG. 9D, the graphical surface treatment 901 is configured so that an eleventh graphical image 964 made up of a set of image segments 965, 966, a twelfth graphical image 967 made up of a set of image segments 968, 969, a thirteenth graphical image 970 made up of a set of image segments 971, 972, a fourteenth graphical image 973 made up of a set of image segments 974, 975, a fifteenth graphical image 976 made up of a set of image segments 977, 978, a sixteenth graphical image 979 made up of a set of image segments 980, 981, a seventeenth graphical image 982 made up of a set of image segments 983, 984, and an eighteenth graphical image 985 made up of a set of image segments 986, 987 are contiguously exhibited within respective small non-square rectangular planar display surfaces 956, 957, 958, 959, 960, 961, 962, 963. The small non-square rectangular planar display surfaces 956, 957, 958, 959, 960, 961, 962, 963 correspond to the small non-square rectangular planar display surfaces 814, 816 formed in the rectangular parallelepiped display configuration 808 shown in FIG. 8 and the small non-square rectangular planar display surface 334 shown in FIG. 3E. According to an example, the rectangular parallelepiped display configuration 808 is formed from two smaller, hingedly connected parallelepipeds. The eight small non-square rectangular planar display surfaces 956, 957, 958, 959, 960, 961, 962, 963 may comprise the lateral surfaces of the two smaller, hingedly connected rectangular parallelepipeds that are alternately shown when the smaller rectangular parallelepipeds are rotated with respect to each other between two abutting positions.

According to an example, the graphical surface treatment 901 may comprise a plurality of graphical surface treatment portions born on substrates 903 having the sets of image segments imprinted thereon, which are then applied to the display facets of the transformational display device 802. The substrates 903 may be cut from a common stock substrate 902. According to the example, the plurality of substrates 903 comprise a plurality of decals or adhesive-backed labels configured to be adhered to the display facets.

As shown, any one of the substrates 903 may have two or more image segments imprinted thereon and the substrates 903 may be applied to two adjoining display facets on one of the plurality of polyhedrons. According to the example shown in FIG. 9A, the graphical surface treatment 901 includes twelve substrates 903 to be applied to each of the respective polyhedrons. Accordingly, the image segments imprinted on each of the substrates 903 are taken from different sets of image segments and comprise portions of different graphical images. Also, the adjoining display facets of each polyhedron having one of the substrates 903 applied thereto form portions of different planar display surfaces.

According to the example of FIG. 8-FIG. 9D, the transformational display device 802 is configurable between seven different display configurations (i.e., one cuboid display configuration 804, four abutting pyramid display configurations 806, and two rectangular parallelepiped display configurations 808) in which the eighteen planar display surfaces 904, 905, 906, 907, 908, 909, 932, 933, 934, 935, 956, 957, 958, 959, 960, 961, 962, 963 are formed such that eighteen graphical images 910, 913, 916, 921, 924, 927, 936, 941, 946, 951, 964, 967, 970, 973, 976, 979, 982, 985 may be contiguously exhibited through manipulation and rearrangement of the transformational display device 802.

Methods for making graphical surface treatments, including the foregoing examples, will now be described. Terms used below have the meanings previously defined herein. Advantageously, said methods enable mass customization of transformational display devices, including but not limited to those previously described. For example, the following methods enable one or more graphical images to be distributed on a graphical surface treatment and applied to a transformational display device such that the transformational display device exhibits the one or more graphical images on planar display surfaces thereof. Said methods may be repeated based on different graphical images, e.g., performed in a first instance using graphical images received from a first party (e.g., a first consumer), in a second instance using different graphical images received from a second party (e.g., a different second consumer), and in n other instances using different graphical images from n different parties.

The transformational display devices provided by the following methods may have the geometry of any one of the transformational display devices 102, 202, 402, 602, 802 described above with reference to FIG. 1A-FIG. 9D. However, the following methods apply to additional transformational display devices having different geometries.

FIG. 10A provides a flow chart for methods 1000 of making graphical surface treatments and transformational display devices in accordance with examples of the present disclosure.

As shown, the method 1000 includes an optional converting step 1002, in which at least two different graphical images comprising a first graphical image and a second graphical image (e.g., digital formats of different photographs, pictures, illustrations, etc.) are converted into partial image segments (e.g., digital partial image segments); a forming step 1004 of forming a physical graphical surface treatment bearing the partial image segments of the different at least two graphical images (e.g., one or more decals); and an applying step 1006 in which the graphical surface treatment is applied to a transformational display device (e.g., using a jig or workpiece to assist the application of one or more decals to the facets of the transformational display device).

Consistent with the previous examples, the transformational display device to which the graphical surface treatment is applied comprises a plurality of polyhedrons connected by joints and configurable between at least a first display configuration and a second display configuration (optionally, display configurations as described above). In the first display configuration, adjacent and coplanar facets of the plurality of polyhedrons form a first planar display surface (e.g., a rhomboidal planar display surface), and in the second display configuration, adjacent and coplanar facets of the plurality of polyhedrons form a second planar display surface (e.g., a triangular planar display surface).

In any embodiment, the method 1000 may be performed with one, two, three, four, five, six, seven, eight, nine, ten, eleven, twelve, thirteen, fourteen, fifteen, sixteen, seventeen, eighteen, nineteen, twenty, or more different graphical images, each of which is mapped to a different planar display surface of the transformational display device. Accordingly, the number of graphical image and planar display surfaces may scale up or down linearly. For example, each step of the method 1000 may be performed in with eight, ten, or twelve different graphical images and a transformational display device configurable between display configurations having, respectively, eight, ten, or twelve different planar display surfaces, i.e., one mapped to each graphical image.

In any embodiment, the transformational display device may be configurable between at least: two, three, four, five, six, seven, eight, nine, ten, eleven, twelve, or more display configurations, any number of which may be different from the others. In any embodiment, each of the different display configurations forms a planar display surface having a different shape than the other planar display surfaces. For example, any embodiment may include display configurations forming planar display surfaces having any combination of the following shapes:
rhomboidal (e.g., non-square rhomboidal), square, rectangular, quadrilateral, triangular (pyramid), and diamond.

The graphical images are converted, the graphical surface treatment is formed and applied to the transformational display device, such that, in the first display configuration, the first planar display surface bears contiguous partial image segments of the first graphical image (e.g., the entire first graphical image), and in the second display configuration, the second planar display surface bears contiguous partial image segments of the second graphical image (e.g., the entire second graphical image).

In any embodiment, each of the graphical images is mapped to a different planar display surface of the transformational display device, the planar display surface having n facets. The mapping step may be performed as part of converting step 1002 or the forming step 1004

In any embodiment, each of the graphical images is converted to a plurality of partial image segments, each having a shape corresponding to a facet of a planar display surface of the transformational display device. For example, each of the graphical images is mapped to a different planar display surface having n facets and then converted to n partial image segments, each partial image segment having a shape corresponding to one of the facets of the planar display surface, e.g., such that all partial image segments of the graphical image are arrangeable in the shape of the mapped planar display surface and contiguously show the graphical image (or a portion thereof).

In any embodiment, the graphical surface treatment is formed by, for each graphical image, preparing physical partial image segments of that graphical image (e.g., a decal, an adhesive-backed label, a printed layer of ink, a printed layer of paint, a printed layer of dye, an etching, an engraving, an embossment, or an inscription), wherein each of the physical partial image segments maps to, i.e., has a same size and a same shape as, a facet of a single planar display surface of the transformational display device mapped to that graphical image, e.g., such that all partial image segments of the graphical image are arrangeable in the shape of the mapped planar display surface and contiguously show the graphical image (or a portion thereof).

In any embodiment, the graphical surface treatment is applied by, for each graphical image, applying physical partial image segments of that graphical image (e.g., a decal, an adhesive-backed label, a printed layer of ink, a printed layer of paint, a printed layer of dye, an etching, an engraving, an embossment, or an inscription) to a facet of a single planar display surface of the transformational display device mapped to that graphical image, e.g., such that all partial image segments of the graphical image are arrangeable in the shape of the mapped planar display surface and contiguously show the graphical image (or a portion thereof).

According to an example, the partial image segments of one or both of the first graphical image and the second graphical image are each different from the other partial image segments. In other words, the partial image segments of one or both of the graphical images are non-repetitive and, in some embodiments, do not exhibit a repetitive pattern or a portion of a pattern that may form a repeating chain of pattern units.

According to an example, during the converting step 1002 the first graphical image and the second graphical image are separated or divided into the partial image segments, with each partial image segment comprising a portion of the respective graphical image.

It is to be appreciated, in accordance with one or more alternative examples of the present disclosure, that the converting step 1002 is optional and is not required to achieve the transformational display device in all circumstances. For instance, a set of partial image segments may be generated that are to be formed into the graphical surface treatment, applied to the transformational display device, and combined into a desired or planned amalgamated image when the set of partial image segments is arranged on a planar display surface.

According to an example, during the forming step 1004, the partial image segments are arranged into a distribution of image segments containing the partial image segments converted from the first graphical image and the second graphical image. The distribution includes the partial image segments converted from each of the first graphical image and the second graphical image separated apart and then sorted together or interspersed in an ordered manner to correspond to the relative positioning of the facets of the plurality of polyhedrons that will form the first planar display surface when the plurality of polyhedrons is physically manipulated into the first display configuration and the second planar display surface when the plurality of polyhedrons is physically manipulated into the second display configuration. In other words, the distribution serves as an ordered layout of all of the partial image segments born on or exhibited by the graphical surface treatment. It is to be appreciated that this distribution may be generated according to an algorithm expressed by executable code programmed into the memory of a computer containing a processor suitable for performing the commands contained in the executable code. The graphical surface treatment may then be printed on a substrate or substrates to be applied to the facets or directly printed or applied to the facets. Such distributions or layouts are implicated by FIG. 5A, FIG. 7A, and FIG. 9A illustrating examples of graphical surface treatments 501, 701, 901 that can be applied to transformational display devices 402, 602, 802 in accordance with the examples of FIG. 4, FIG. 6, and FIG. 8, respectively.

In some examples, at least one partial image segment from the first graphical image of the at least two graphical images is provided on the graphical surface treatment between image segments from a second graphical image of the at least two graphical images, e.g., as shown in FIG. 5A, FIG. 7A, and FIG. 9A. In some examples, the partial image segments from the at least two graphical images are distributed on the graphical surface treatment such that at least one (e.g., all) of the at least two graphical images are not contiguously exhibited on the graphical surface treatment.

According to the example, the applying step 1006 includes applying the graphical surface treatment formed from the distribution of image segments to the plurality of polyhedrons such that the partial image segments born on or exhibited by the graphical surface treatment are mapped and applied to the corresponding facets forming the first planar display surface and the second planar display surface such that the first planar display surface exhibits the first graphical image and the second planar display surface exhibits the second graphical image.

It is to be appreciated that the method 1000 may be expanded or “scaled up” so that a transformational display device exhibiting additional graphical images, i.e., more than two, on additional planar display surfaces formed in additional display configurations. This may be achieved by converting each of the additional graphical images into partial image segments, as discussed above, and then forming a graphical surface treatment from a distribution containing the sorted image segments from all of the graphical images (e.g., at least three total graphical images, twelve total graphical images, or eighteen total graphical images, etc.). Accordingly, the number of graphical images that may be exhibited by a transformational display device may only be limited by the geometry of the transformational display device, i.e., the number of polyhedrons contained in the device, the number of facets each polyhedron may have, and the number of planar display surfaces that may be achieved by physically manipulating and arranging the plurality of polyhedrons. According to a particular example, the transformational display device has a structure and geometry corresponding to the structure and geometry of the transformational display device 102 described above with reference to FIG. 1A-FIG. 1C.

According to an example, the forming step 1004 comprises forming a first graphical surface treatment portion bearing at least one partial segment of the first graphical image, and forming a second graphical surface treatment portion bearing at least one partial image segment of the second graphical image. The applying step 1006 comprises applying at least the first graphical surface treatment portion across the first planar display surface and applying at least the second graphical surface treatment portion across the second planar display surface. The first graphical surface treatment portion and the second graphical surface treatment portion may form joints or living hinges therebetween. According to another example, the forming step 1004 comprises imprinting the partial image segments on a common stock substrate and forming a plurality of graphical surface treatment portions therefrom.

According to an example, the first planar display surface and the second planar display surface have different shapes. According to a particular example, the first planar display surface has a non-square rhomboid shape and the second planar display surface has a triangular shape.

According to an example, in the first display configuration, the first planar display surface is coextensive with a first outermost face of the transformational display device, and in the second display configuration, the second planar display surface is coextensive with a second outermost face of the transformational display device. According to the example, the first outermost face and the second outermost face may have different shapes.

According to an example, at least four adjacent and coplanar facets form the first planar display surface, and at least six adjacent and coplanar facets form the second planar display surface.

According to another example, the graphical surface treatment comprises triangular partial image segments of the at least two different graphical images. It is to be appreciated, as discussed above, that the shape of the partial image segments may be determined by the shape and configuration(s) of the facets of the plurality of polyhedrons. According to a particular example, the triangular shape of the partial image segments corresponds to the triangular shape of the facets of the plurality of polyhedrons, as discussed above with reference to FIG. 1A-FIG. 1C.

According to an example, in the first display configuration, facets of at least four of the plurality of polyhedrons form the first planar display surface. In the second display configuration, facets of at least four of the plurality of polyhedrons may form the second planar display surface. According to another example, the first planar display surface and the second planar display surface may have a same planar non-square rhomboidal shape. Alternatively, the first planar display surface may have a non-square rhomboidal shape and the second planar display surface may have a planar hexagonal shape. Alternatively, the first planar display surface may have a non-square rhomboidal shape and the second planar display surface may have a planar triangular shape.

According to an example, the first display configuration and the second display configuration have different geometric shapes.

With reference to FIG. 10B, according to an example, the converting step 1002 comprises a receiving step 1008 in which the at least two different graphical images are first received, e.g., in a digital format, and a dividing step 1010 in which the at least two different graphical images are divided or separated into the partial image segments. According to the example, the forming step 1004 may comprise printing the partial image segments on at least one substrate.

Also, according to the example, the converting step 1002 may additionally or alternatively comprise a cropping step 1012 in which the at least two graphical images are cropped based upon a shape of the first planar display surface and a shape of the second planar display surface. In other words, the graphical images may be cropped and re-sized to fit on one of the planar display surfaces formed by the transformational display device. According to an example, the shape of the first planar display surface is a rhomboid shape and the shape of the second planar display surface is a triangular shape.

With reference to FIG. 10C, according to an example, the method 1000 further comprises a previewing step 1014, in which a preview of the at least two different graphical images on at least two planar display surfaces, including the first planar display surface and the second planar display surface, is provided through a graphical user interface, e.g., a browser-based user interface. The previewing step 1014 may comprise a confirmation step 1016 in which a confirmation of the previewed at least one possible planar display surface is received.

Accordingly, the present disclosure provides for previewing of the possible planar display surfaces of a customized transformational display device during the process of making transformational display device. The consumer, vendor, or licensee providing the graphical images to be applied to the transformational display device is able to view the appearance and arrangement of the graphical images on the possible planar display surfaces and provide a confirmation that the previewed transformational display device is satisfactory before the process continues to the forming step 1004 and the applying step 1006.

According to an example, the consumer, vendor, or licensee submitting the graphical images may use a computer or other device connected to the Internet to access a remote connected server hosting a website or similar interface designated for receiving the graphical images and configured to provide previews the possible planar display surfaces to the consumer, vendor, or licensee. The website may be configured to preview one of, some of, and/or all of the possible planar display surfaces that may be generated from the submitted graphical images on the graphical user interface, e.g., browser based interface, and to receive confirmation to proceed to the subsequent forming step 1004 and applying step 1006 either directly, such as through one or more “Confirmation” controls, or indirectly, such as through a “Buy Now” or “Add to Cart” control. According to this example, the website may be contain or be connected to programming that converts the received graphical images into the partial image segments so that the image segments may be properly arranged with respect to each other to generate the previewed possible planar display surfaces.

It is to be appreciated that the previewing step 1014 may be performed without access to a website via a browser based interface. Alternatively, the graphical images may be received and the possible planar display surfaces previewed at a terminal located in a store or production facility. Or the previewing step 1014 may be performed in person using a personal computing device containing the appropriate programming or having access to such programming.

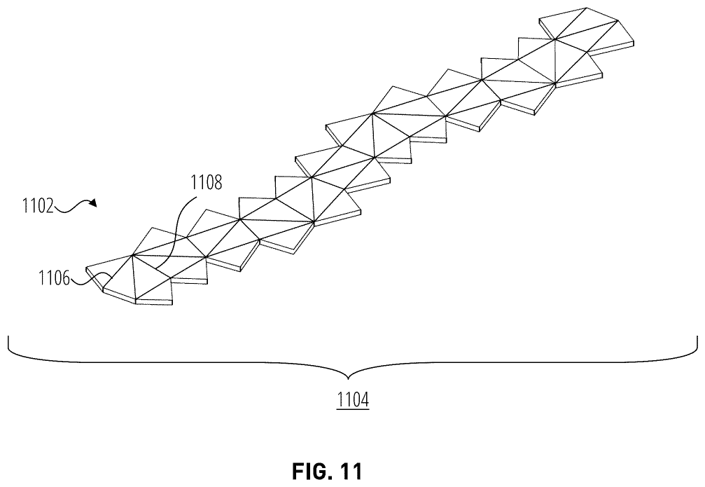

FIG. 11 illustrates a substrate 1102 that may be used in connection with the method 1000 described above with reference to FIG. 10A-FIG. 10C. According to an example, the substrate 1102 comprises a plurality of facets 1104 that are hingedly connected and rotatable with respect to each other about joints 1106, 1108. The facets 1104 are also sized and shaped so as to be configured to form a plurality of polyhedrons having the same or a similar geometry to the plurality of polyhedrons of the transformational display device 102 described above with reference to FIG. 1A-FIG. 1C. Alternatively, the facets 1104 may be configured form a plurality of polyhedrons having a different geometry.

According to an example, the substrate 1102 comprises at least one piece of foldable material with the plurality of facets 1104 formed or defined therein. The facets 1104 are foldable with respect to each other so as to form the hinged joints 1106 between individual facets of one of the plurality of polyhedrons and the hinged joints 1108 formed between adjacent polyhedrons. According to an example, the foldable material of the substrate 1102 may comprise paper, cardstock, cardboard, or plastic. Alternatively, according to an example, the substrate 1102 may comprise a plurality of rigid facets 1104 that are hingedly interconnected at the joints 1106, 1108 to form the plurality of polyhedrons.

Accordingly, the transformational display device can be provided as a flat substrate 1102 that can be more easily stored prior to the applying step 1006. Further, the flat substrate 1102 may be directly imprinted with the partial image segments and subsequently folded into the plurality of polyhedrons to allow for on-demand making of the transformational display device at a point of sale, such as a kiosk or a photo counter at a department store, pharmacy, or grocery store. The folding may be undertaken at the point of sale or by the consumer after receiving the transformational display device. Alternatively, the image segments may be imprinted on a plurality of adhesive-backed labels affixed to a common stock substrate (e.g., a plurality of stickers), which are then peeled from the substrate and applied to the substrate 1102 either at the point of sale or by the consumer before or after folding. According to another alternative, the flat substrate 1102 may be sold as a standalone piece and the consumer may use a printing and cutting template to form the adhesive-backed labels on a suitable home device. Further, a cutting template may be provided to a consumer for forming the flat substrate 1102 from a stock piece of paper, cardstock, cardboard, or plastic on a suitable home device.

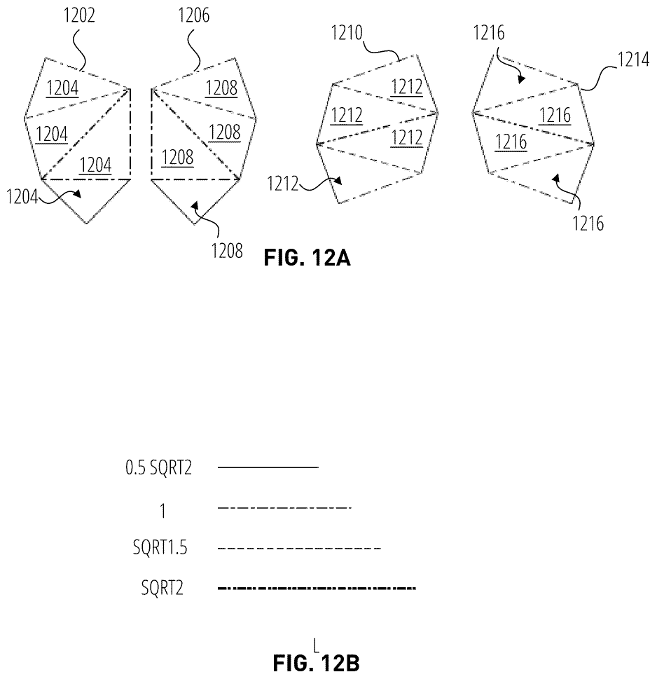

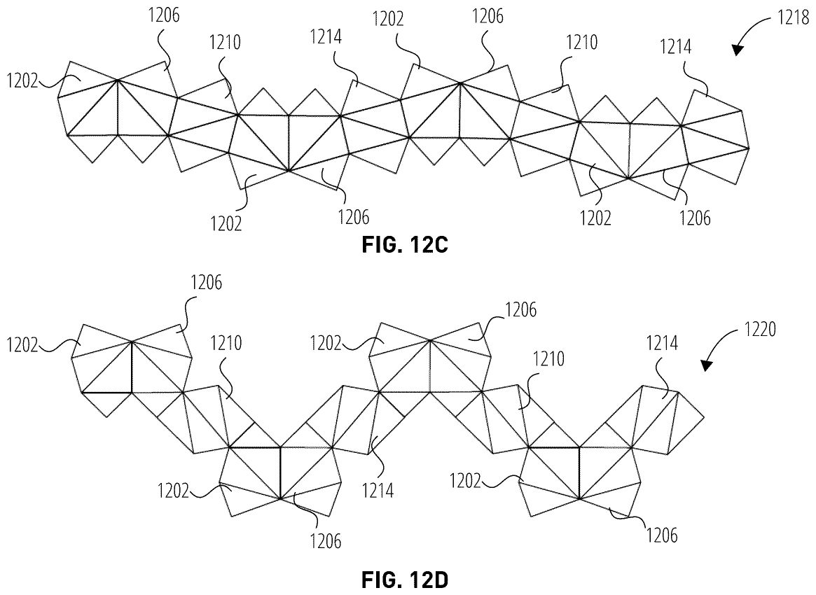

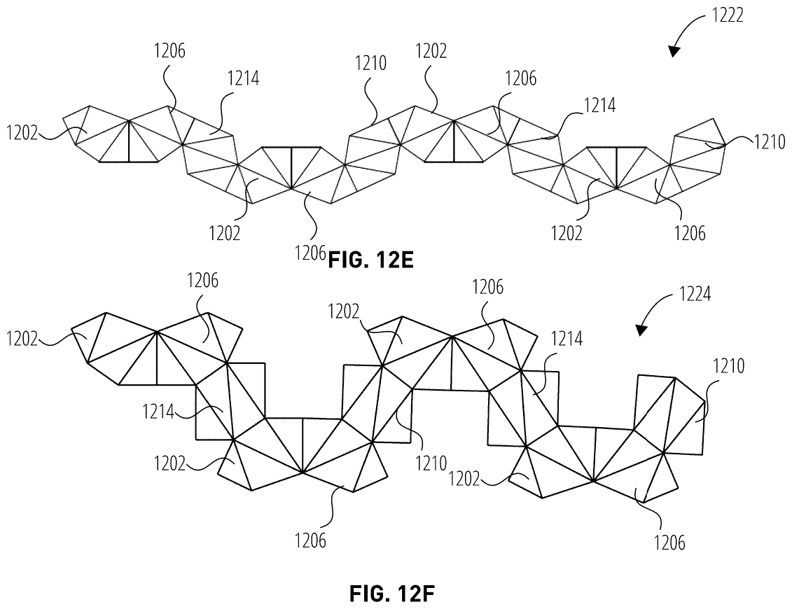

FIG. 12A-FIG. 12F illustrate a number of transformational display devices 1218, 1220, 1222, 1224 in accordance with another example of the present disclosure. The transformational display devices 1218, 1220, 1222, 1224 shown in FIG. 12A-FIG. 12F present various alternative geometries to the transformational display device 102 described above with reference to FIG. 1A-FIG. 1C. As shown in FIG. 12A, the transformational display devices 1218, 1220, 1222, 1224 each comprise a plurality of polyhedrons 1202, 1206, 1210, 1214 of different geometries. Each polyhedron 1202, 1206, 1210, 1214 comprises a plurality of facets 1204, 1208, 1212, 1216. As shown in FIG. 12A, the first and second polyhedrons 1202, 1206 are mirror images of each other and the third and fourth polyhedrons 1210, 1216 are mirror images of each other.

FIG. 12A shows the geometries of each of the polyhedrons 1202, 1206, 1210, 1214. The relative scales and the relationship between the side lengths of each of the polyhedrons 1202, 1206, 1210, 1214 are set forth in the legend shown in FIG. 12B. The sides illustrated in the long dashed-short dashed line pattern have a length of one unit, which may be scaled up or down in different embodiments. Regardless of the numerical value of the long dashed-short dashed line pattern unit, the relative relationships between the different sides remain constant between different embodiments. Restated, regardless of the numerical value of the long dashed-short dashed line pattern length, the sides illustrated in a solid line pattern have a side length equal to 0.5√(2)(unit length) (i.e., 0.5 times the square root of two times the unit length), the sides illustrated in the dashed line pattern have a side length equal to √(1.5)(unit length) (i.e., square root of one and one-half times the unit length), and the sides illustrated in the dot-dot-dashed line pattern have a side length equal to √(2)(unit length) (i.e., the square root of two times the unit length).

As shown in FIG. 12C-FIG. 12F, the geometries of the plurality of polyhedrons 1202, 1206, 1210, 1216 lead to multiple different congruencies between the facets 1204, 1206, 1208, 1210 of the polyhedrons 1202, 1206, 1210, 1216 and therefore different shaped display configurations and planar display surfaces that can be achieved through manipulation and rearrangement of the plurality of polyhedrons 1202, 1206, 1210, 1216 depending on the arrangements and relative orientations of the polyhedrons 1202, 1206, 1210, 1216 when linked together by joints in a loop arrangement 104, as described above with reference to the transformational display device 102 shown in FIG. 1A-FIG. 1C.

In particular, FIG. 12C shows a transformational display device 1218 comprised of twelve polyhedrons 1202, 1206, 1210, 1214 adjoined in the following order: 1202-1206-1210-1202-1206-1214-1202-1206-1210-1202-1206-1214. The polyhedrons 1202, 1206, 1210, 1214 are oriented with respect to each other so that the sides of each of the polyhedrons 1202, 1206, 1208, 1210 having a side length equal to √(2)(unit length) (dot-dot-dashed line pattern) meet at angles with respect to each other to form a series of equilateral triangles between the adjoining facets of the polyhedrons 1202, 1206, 1210, 1216.

FIG. 12D shows a transformational display device 1220 comprised of twelve polyhedrons 1202, 1206, 1210, 1216 adjoined in the following order: 1202-1206-1210-1202-1206-1214-1202-1206-1210-1202-1206-1214. The polyhedrons 1202, 1206, 1210, 1214 are oriented with respect to each other so that the sides of the third polyhedron 1210 and the fourth polyhedron 1214 having a side length equal to √(2)(unit length) (dot-dot-dashed line pattern) are aligned with the with the sides of the first polyhedron 1202 and the second polyhedron 1206 having a side length equal to √(2)(unit length) (dot-dot-dashed line pattern), which forms a series of deep V-shaped patterns in the loop arrangement of the transformational display device 1220.

FIG. 12E shows a transformational display device 1222 comprised of twelve polyhedrons 1202, 1206, 1210, 1214 adjoined in the following order: 1202-1206-1214-1202-1206-1210-1202-1206-1214-1202-1206-1210. The polyhedrons are oriented with respect to each other so that the sides of the first polyhedron 1202 and the second polyhedron 1206 having a side length equal to √(1.5)(unit length) (dashed line pattern) meet at angles with respect to each other to form equilateral triangles between the adjoining facets of the polyhedrons 1202, 1206 and the sides of the third polyhedron 1210 and the fourth polyhedron 1214 having a side length equal to √(2)(unit length) (dot-dot-dashed line pattern) are aligned with the sides of the first polyhedron 1202 and the second polyhedron 1206 having a side length equal to √(2)(unit length) (dot-dot-dashed line pattern), which forms a series of shallow V-shaped patterns in the loop arrangement of the transformational display device 1222.

FIG. 12F shows a transformational display device 1224 comprised of twelve polyhedrons 1202, 1206, 1210, 1214 adjoined in the following order: 1202-1206-1214-1202-1206-1210-1202-1206-1214-1202-1206-1210. The polyhedrons are oriented with respect to each other so that the sides of the first polyhedron 1202 and the second polyhedron 1206 having a side length equal to √(1.5)(unit length) (dashed line pattern) meet at angles with respect to each other to form equilateral triangles between the adjoining facets of the polyhedrons 1202, 1206. The sides of the third polyhedron 1210 and the fourth polyhedron 1214 having a side length equal to √(2)(unit length) (dot-dot-dashed line pattern) meet at angles with respect to the sides of the first polyhedron 1202 and the second polyhedron 1206 having a side length equal to √(2)(unit length) (dot-dot-dashed line pattern) to form equilateral triangles between the adjoining facets of the third polyhedron 1210 and the first and second polyhedrons 1202, 1206 and between the adjoining facets of the fourth polyhedron 1414 and the first and second polyhedrons 1402, 1406. The above-described orientations of the polyhedrons 1402, 1406, 1410, 1414 forms a series of deep U-shaped patterns in the loop arrangement of the transformational display device 1424.

As used herein, the singular forms of “a”, “an”, and “the” include plural referents unless the context clearly states otherwise.

As used herein, the terms “right”, “left”, “top”, and derivatives thereof shall relate to the invention as it is oriented in the drawing figures. However, it is to be understood that the invention can assume various alternative orientations and, accordingly, such terms are not to be considered as limiting. Also, it is to be understood that the invention can assume various alternative variations and stage sequences, except where expressly specified to the contrary. It is also to be understood that the specific devices and processes illustrated in the attached drawings and described in the following specification are examples. Hence, specific dimensions and other physical characteristics related to the embodiments disclosed herein are not to be considered as limiting.

Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrases “at least one of A, B, and C,” “at least one of A, B, or C,” or similar expressions referencing two or more elements includes: (A), (B), (C), (A and B), (A and C), (B and C), or (A, B, and C), including all further possible permutations when greater than three elements are listed.

Unless otherwise indicated, all numbers expressing quantities of ingredients, reaction conditions, dimensions, physical characteristics, and so forth used in the specification and claims are to be understood as being modified in all instances by the term “about,” which means plus or minus 5% unless otherwise apparent from the disclosure. Unless indicated to the contrary, the numerical parameters set forth in the following specification and attached claims are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Also, it should be understood that any numerical range recited herein is intended to include all sub-ranges subsumed therein. For example, a range of “1 to 10” is intended to include any and all sub-ranges between and including the recited minimum value of 1 and the recited maximum value of 10. That is, all subranges beginning with a minimum value equal to or greater than 1 and ending with a maximum value equal to or less than 10, and all subranges in between, e.g., 1 to 6.3, or 5.5 to 10, or 2.7 to 6.1.

The preceding examples and embodiments of the invention have been described with reference to various examples. Modifications and alterations will occur to others upon reading and understanding the foregoing examples. Accordingly, the foregoing examples are not to be construed as limiting the disclosure.

1. A method of making a transformational display device, comprising:
converting at least two different graphical images comprising a first graphical image and a second graphical image into partial image segments;
forming a graphical surface treatment bearing the partial image segments of the at least two different graphical images; and
applying the graphical surface treatment to a transformational display device comprising a plurality of polyhedrons connected by joints and configurable between a first display configuration and a second display configuration, such that in the first display configuration, adjacent and coplanar facets of the plurality of polyhedrons form a first planar display surface bearing contiguous partial image segments of the first graphical image, and in the second display configuration, adjacent and coplanar facets of the plurality of polyhedrons form a second planar display surface bearing contiguous partial image segments of the second graphical image.

2. The method according to claim 1, wherein the first display configuration and the second display configuration have different shapes.

3. The method according to claim 1, wherein the first planar display surface and the second planar display surface have different shapes.

4. The method of claim 3, wherein the first planar display surface has a rhomboid shape and the second planar display surface has a triangular shape.

5. The method of claim 1, wherein forming the graphical surface treatment comprises forming a first graphical surface treatment portion bearing at least one partial image segment of the first graphical image, and forming a second graphical surface treatment portion bearing at least one partial image segment of the second graphical image.

6. The method of claim 5, wherein forming the graphical surface treatment comprises forming the first graphical surface treatment portion bearing at least two partial image segments of the first graphical image, and forming the second graphical surface treatment portion bearing at least two partial image segments of the second graphical image.

7. The method of claim 5, wherein applying the graphical surface treatment comprises applying at least the first graphical surface treatment portion across the first planar display surface and applying at least the second graphical surface treatment portion across the second planar display surface.

8. The method of claim 7, wherein the first graphical surface treatment portion and the second graphical surface treatment portion form living hinges.

9. The method of claim 1, wherein each partial image segment of the first graphical image maps to a facet of the first planar display surface, and wherein each partial image segment of the second planar display surface maps a facet of the second planar display surface.

10. The method of claim 1, wherein applying the graphical surface treatment comprises applying the partial image segments of the first graphical image to facets of the first planar display surface, and applying the partial image segments of the second graphical image to facets of the second planar display surface.

11. The method of claim 1, wherein at least four adjacent and coplanar facets form the first planar display surface, wherein at least six adjacent and coplanar facets form the second planar display surface.

12. The method of claim 1, wherein the graphical surface treatment comprises triangular partial image segments of the at least two different graphical images.

13. The method of claim 1, wherein converting the at least two different graphical images into the partial image segments comprises receiving the at least two different graphical images in a digital format and dividing the at least two different graphical images into the partial image segments.

14. The method of claim 13, wherein forming the graphical surface treatment comprises printing the partial image segments on at least one substrate.

15. (canceled)

16. The method of claim 13, wherein converting the at least two graphical images into the partial image segments comprises cropping the at least two graphical images based upon a shape of the first planar display surface and a shape of the second planar display surface.

17. (canceled)

18. The method of claim 1, wherein in the first display configuration, facets of at least four of the plurality of polyhedrons form the first planar display surface.

19. The method of claim 18, wherein in the second display configuration, facets of at least four of the plurality of polyhedrons form the second planar display surface.

20-22. (canceled)

23. The method of claim 1, further comprising providing, through a graphical user interface, a preview of the at least two different graphical images on at least two planar display surfaces, including the first planar display surface and the second planar display surface.

24. A method of making a transformational display device, comprising:
converting at least two different graphical images comprising a first graphical image and a second graphical image into partial image segments;
forming a graphical surface treatment bearing the partial image segments of the at least two different graphical images; and
applying the graphical surface treatment to a transformational display device comprising a plurality of polyhedrons connected by joints and configurable between a first display configuration and a second display configuration, wherein in the first display configuration, adjacent and coplanar facets of the plurality of polyhedrons form a first planar display surface, and in the second display configuration, adjacent and coplanar facets of the plurality of polyhedrons form a second planar display surface;
wherein each partial image segment of the first graphical image maps to a facet of the first planar display surface, and wherein each partial image segment of the second planar display surface maps to a facet of the second planar display surface;
wherein applying the graphical surface treatment comprises applying the partial image segments of the first graphical image to facets of the first planar display surface, and applying the partial image segments of the second graphical image to facets of the second planar display surface.

25. A method of making a transformational display device comprising a plurality of polyhedrons connected by joints and configurable between a first display configuration and a second display configuration, wherein in the first display configuration, adjacent and coplanar facets of the plurality of polyhedrons form a first planar display surface, and in the second display configuration, adjacent and coplanar facets of the plurality of polyhedrons form a second planar display surface, the method comprising:
converting at least two different graphical images comprising a first graphical image and a second graphical image into partial image segments;
forming a graphical surface treatment bearing the partial image segments of the at least two different graphical images, wherein each partial image segment of the first graphical image maps to a facet of the first planar display surface, and wherein each partial image segment of the second planar display surface maps to a facet of the second planar display surface; and
applying the graphical surface treatment to the transformational display device by applying the partial image segments of the first graphical image to facets of the first planar display surface, and applying the partial image segments of the second graphical image to facets of the second planar display surface.
